(19) United States
(12) Patent Application Publication
(10) Pub. No.: US 2023/0178746 A1
(43) Pub. Date: Jun. 8, 2023

(54) NANOMATERIAL COMPOSITIONS AND METHODS OF MAKING THE SAME

(71) Applicant: Donaldson Company, Inc., Bloomington, MN (US)

(72) Inventors: Patricia A. Ignacio-de Leon, Minnetonka, MN (US); Rakesh K. Yadav, Woodbury, MN (US); Jared R. Moody, Minneapplis, MN (US)

(21) Appl. No.: 18/074,349

(22) Filed: Dec. 2, 2022

Related U.S. Application Data
(60) Provisional application No. 63/285,903, filed on Dec. 3, 2021.

(51) Int. Cl. H01M 4/62; C08L 39/06; C08L 77/00; C08K 3/28; D04H 3/009; D04H 3/16; D04H 3/007; D01D 5/00; H01M 4/66; H01M 4/525; H01M 4/131; H01M 10/0525; H01M 4/505

(52) U.S. Cl. CPC H01M 4/623; C08L 39/06; C08L 77/00; C08K 3/28; D04H 3/009; D04H 3/16; D04H 3/007; D01D 5/0084; D01D 5/0038; H01M 4/661; H01M 4/525; H01M 4/131; H01M 10/0525; H01M 4/505; C08L 2203/12; D10B 2321/12; D10B 2331/02; D10B 2321/042; H01M 2004/021

(57) ABSTRACT

Nanoparticle compositions, electrospun nonwoven material compositions, and methods of making the same are disclosed. The nanoparticles may be made by electrospinning a composition including a sacrificial polymer and first and second ion species into fibers, and decomposing at least a portion of the sacrificial polymer. The nanoparticles may include an electroactive compound. The nanoparticles may include a catalytically active compound. The nanoparticles may further be included in a composition prepared into a nonwoven material. The nonwoven material may be used to prepare battery compositions. The battery compositions may include an electrode that includes the nanoparticles.

### CROSS REFERENCE TO RELATED APPLICATIONS

This application claims the benefit of U.S. Provisional Application No. 63/285,903, filed 3 Dec. 2021, the disclosure of which is incorporated by reference herein in its entirety.

### FIELD

The present disclosure relates to nanomaterial compositions and methods of making and using the same. In particular, the present disclosure relates to nonwoven material compositions and methods of making and using the same. The present disclosure further relates to particle compositions and methods of making and using the same.

### BACKGROUND

Nanomaterials, such as nanoparticles, are becoming ubiquitous in consumer and industrial products. However, the nano- and/or meso-structure of the nanomaterial directly impacts the performance of the nanomaterial in various applications including, for example, in electrode assemblies and as catalysts. For example, smaller nanoparticles tend to have a higher catalytic efficiency when compared to relatively larger nanoparticles due to a larger surface area to volume ratio. Additionally, relatively smaller nanoparticles are desired for use in electrode assemblies due to their decreased propensity for dislocations and other crystalline deformations. Furthermore, the mesostructure of an electrode assembly containing nanoparticles may greatly influence the electrochemical performance of the assembly. For example, electrodes that include high aspect ratio nanomaterials are promising for use in high performance lithium-ion batteries.

The production method used to make nanomaterials influences the nanostructure, the mesostructure, and the morphology distribution of the nanomaterials. Nanoparticles may be made by a top-down method which involves reducing macro structures to nanostructures, or by a bottom-up method which involves building a nano structure from atoms. The top-down method generates relatively large nanoparticles with an uneven distribution in size and morphology, while also producing many waste products. Common bottom-up methods include flame reactor processes, plasma reactor processes, laser reactor processes, hot wall reactor processes, chemical or gas phase deposition, precipitation processes, and sol-gel processes. These manufacturing methods often require harsh conditions, produce nanoparticles with an uneven distribution in size and morphology, require optimization of reaction kinetics, or require extensive post processing to isolate the nanoparticles. Regarding nanomaterial-containing electrodes, conventional preparation is done via slurry casting. However, slurry casting produces nonuniform mesostructures resulting in sluggish electron transport.

Further improvements to the manufacturing process of nanoparticles are needed. Additionally, improved electroactive nanomaterials, and the process of making such nanomaterials, are needed.

### SUMMARY

The present disclosure describes, in one aspect, a composition that includes an electrospun nonwoven material. The electrospun nonwoven material includes a fiber having an average diameter of less than 5 μm. The fiber includes a sacrificial polymer present at 40 weight-% to 60 weight-% of a total weight of the electrospun nonwoven material; and a first ion species and a second ion species dispersed on the sacrificial polymer and distributed along the fiber, the first ion species and the second ion species being ion specie of at least one salt, the at least one salt being present at 60 weight-% or less of a weight-% of a total salt, the weight-% of the total salt relative to a weight-% of the sacrificial polymer is 1 part or more of the total salt weight-% to every 6 parts of the sacrificial polymer weight-%.

The at least one salt may include NiCl₂, Ni(CH₃COO)₂, ZnSO₄, Zn(CH₃COO)₂, KCl, KAuCl₄, CoCl₂, Co(CH₃COO)₂, CuCl₂, Cu(NO₃)₂, PdCl₆, K₂PdCl₆, Na₂PtCl₄, K₂PtBr₄, Ni(NO₃)₂, Co(NO₃)₂, Mn(NO₃)₂, Al(NO₃)₃, Fe(NO₃)₂, LiNO₃, LiH₂PO₄, Fe(CH₃COO)₂, NiSO₄, CoSO₄, Li₂SO₄, MnSO₄, FeSO₄, Al₂(SO₄)₃, Al(OCH₃)₃, Al(CH₃COO)₃, or a combination thereof.

The sacrificial polymer may be polyvinylpyrrolidone, polyethyleneglycol, nylon, polyurethane, polyvinyl alcohol, polyvinylacetate, polyacrylonitrile, polyacrylate, or a combination thereof.

The weight-% of the total salt relative to the weight-% of sacrificial polymer may be from 1:6 to 2:1, from 1:3 to 5:3, from 2:3 to 5:3, from 2:3 to 4:3, or from 1:3 to 4:3.

A composition including an electrospun nonwoven layer includes a substrate; and a fiber deposited onto the substrate by electrospinning. The fiber includes a polymer; and a plurality of nanoparticles dispersed on the polymer and distributed across the fiber, the plurality of nanoparticles having a particle size range from 0.01 μm to 0.5 μm, each nanoparticle comprising a plurality of at least one compound species. A plurality of the fibers may form a first fiber layer. The composition may further include a second fiber layer including second fibers deposited onto the first fiber layer by electrospinning. The second fibers include a second polymer; and a second plurality of nanoparticles dispersed on the second polymer and distributed across the fiber, the second plurality of nanoparticles having a particle size range from 0.01 μm to 0.5 μm, each nanoparticle including a plurality of at least one compound species, wherein the first fiber layer has a solidity that is at least 1.1 times of a solidity of the second fiber layer.

The plurality of nanoparticles may be a first plurality of nanoparticles with each nanoparticle comprising a first compound species, and the composition may further include a second plurality of nanoparticles with each nanoparticle comprising a second compound species different from the first compound species.

The fiber may have an average diameter of less than 1 μm. The polymer may be a binder polymer. The polymer may include one or more polyamides, polysulfones, polyethers, polyesters, polyamines, polyalcohols, polyurethanes, polycarbonates, polyaromatics, photosensitive polymers, polyimides, polyacrylates, polyvinylidenedifluoride, or a combination thereof.

The electrospun nonwoven layer may further include a conductive material. The conductive material may be a carbon powder. The substrate may be a current collector. The substrate may include Cu foil, Al foil, Pt foil, Ni foil, a woven substrate, a nonwoven substrate, an artificial solid electrolyte interface, or a combination thereof.

The at least one compound species may be electroactive. The at least one compound species may include LiCoO₂, LiFePO₄, LiMn₂O₄, LiNiO₂, Li(NiₓMn_{y}Co_{z})O₂, Li(NiₓAl_{y}Co_{z})O₂, or a combination thereof, wherein x+y+z=1. The at least one compound species may be catalytically active. The at least one compound species may include PbSe, AuPt, AuPd, PtPd, PtRu, PtAg, PtCu, FeRu, FeCu, FeRh, CuCe, AuCu, PtIr, NiCu, NiSn, NiAl, PtAl₂, PtMg, PtSn, PtCo, PdCo, PdTi, PtRh, NiAu, RhAg, TiO₂, NiO, or a combination thereof.

A battery may include an electrode including any of the compositions described above.

A battery may include an electrode comprising a plurality of nanoparticles, each nanoparticle including a plurality of at least one electroactive compound species, the plurality of nanoparticles having a particle size range from 0.01 μm to 0.5 μm. The electrode may include an electrospun nonwoven layer comprising a substrate and a fiber deposited onto the substrate by electrospinning, the fiber including: a binder polymer; and the plurality of nanoparticles dispersed on the binder polymer and distributed across the fiber. The plurality of nanoparticles may have a particle size range from 0.02 μm to 0.4 μm.

The binder polymer may include one or more polyamides, polysulfones, polyethers, polyesters, polyamines, polyalcohols, polyurethanes, polycarbonates, polyaromatics, photosensitive polymers, polyimides, or a combination thereof.

A method includes electrospinning a solution onto a substrate, the solution including: a binder polymer; a solvent; and a plurality of nanoparticles, each nanoparticle including a plurality of at least one compound species, the plurality of nanoparticles having a particle size range from 0.01 μm to 0.5 μm; and producing a nonwoven layer comprising a fiber including: the binder polymer; and the plurality of nanoparticles dispersed within the binder polymer and distributed across the fiber. The fiber may have an average diameter of less than 5 μm. The at least one compound species may be electroactive. The at least one compound species may include LiCoO₂, LiFePO₄, LiMn₂O₄, LiNiO₂, Li(NiₓMn_{y}Co_{z})O₂, and Li(NiₓAl_{y}Co_{z})O₂, where x+y+z=1. The at least one compound species may be catalytically active. The at least one compound species may include PbSe, AuPt, AuPd, PtPd, PtRu, PtAg, PtCu, FeRu, FeCu, FeRh, CuCe, AuCu, PtIr, NiCu, NiSn, NiAl, PtAl₂, PtMg, PtSn, PtCo, PdCo, PdTi, PtRh, NiAu, RhAg, TiO₂, NiO, or a combination thereof.

A method includes dissolving at least one salt and a sacrificial polymer in a solvent to form a solution, the solution including: the sacrificial polymer; a first ion species; a second ions species; and the solvent; electrospinning the solution to form a sacrificial nonwoven material including a fiber including: the sacrificial polymer; and the first ion species and the second ion species dispersed on the polymer and distributed along the fiber; and decomposing at least a portion of the sacrificial nonwoven material resulting in a plurality of nanoparticles, each nanoparticle comprising a plurality of at least one compound species, the at least one compound species comprising a reaction product of at least the first ion species and the second ion species, the plurality of nanoparticles having a particle size range from 0.02 μm to 0.5 μm.

The method may further include spinning a mixture onto a substrate, the mixture including: a binder polymer; and the plurality of nanoparticles, the electrospinning of the mixture resulting in a second nonwoven layer comprising a second fiber including: the binder polymer; and nanoparticles from the plurality of nanoparticles, dispersed within the binder polymer and distributed across the fiber.

The at least one salt may include LiNO₃, LiH₂PO₄, Co(NO₃)₂, Ni(NO₃)₂, Fe(NO₃)₂, Mn(NO₃)₂, Al(NO₃)₃, Li₂SO₄, CoSO₄, NiSO₄, FeSO₄, MnSO₄, Al₂(SO₄)₃, Fe(CH₃COO)₂, Al(OCH₃)₃, Al(CH₃COO)₃, or a combination thereof. The at least one salt may include (NH₄)AuCl₄, NaAuBr, HAuCl₄, KCl, KAuCl₄, Na₂PdCl₄, K₂PdBr₄, PdCl₆, K₂PdCl₆, (NH₄)₂PDCl₄, K₂PdCl₄, Na₂PtCl₄, K₂PtBr₄, PtCl₆, K₂PtCl₄, (NH₄)₂PtCl₄, K₂Pt(NO₂)₄, KAg(CN)₂, KCu, Ni(NO₃)₂, Mg(NO₃)₂, NiCl₂, PdCl₂, Ni(Ac)₂, NiBr₂, NiI₂, NiSO₄, Pb(CH₃COO)₂, SeCl₂, Se(CH₃COO)₂, SeBr₄, ZnSO₄, Zn(CH₃COO)₂, Zn(NO₃)₂, ZnCl₂, FeCl₂, FeSO₄, Fe(NO₃)₂, RuCl₃, Ru(NO₃)₃, RhCl₃, Rh(NO₃)₃, IrCl₄, Ir₂(SO₄)₃, CuCl₂, Cu(NO₃)₂, CuSO₄, Cu(CH₃COO)₂, SnCl₄, Sn(CH₃COO)₂, SnSO₄, Sn(NO₃)₄, AlCl₃, Al₂(SO₄)₃, Al(NO₃)₃, MgCl₂, MgSO₄, CoCl₂, Co(CH₃COO)₂, CoSO₄, Co(NO₃)₂, or a combination thereof.

The sacrificial polymer may include polyvinylpyrrolidone, polyethylene glycol, polyvinyl alcohol, polyvinylacetate, polyacrylonitrile, polyacrylate, polyamides, polysulfones, polyethers, polyesters, polyamines, polyalcohols, polyurethanes, polycarbonates, polyaromatics, photosensitive polymers, polyimides, or a combination thereof.

The decomposing may include a heat treatment. The heat treatment may include pyrolysis at 500° C. to 1100° C.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF FIGURES

The discussion below refers to the following figures, wherein the same reference number may be used to identify the similar/same component in multiple figures. The drawings are not necessarily to scale.

FIG. 1 is schematic view of a process used to make nanoparticles according to an embodiment.

FIG. 2 is a schematic view of a process used to make an electrode assembly according to an embodiment.

FIG. 3 is a schematic view of a process used to make a catalyst assembly according to an embodiment.

FIG. 4A is a schematic cross-sectional view of a battery according to an embodiment.

FIG. 4B is a schematic cross-sectional view of an electrode used in the battery of FIG. 4A.

FIG. 5 is an SEM image of electrospun fibers of solution 3 in Example 1.

FIG. 6 is an SEM image of electrospun fibers of solution 5 in Example 1.

FIG. 7 is an SEM image of electrospun fibers of solution 6 in Example 1.

FIG. 8 is a TEM image of the nanoparticles of LiCoO₂ formed after pyrolysis of the nonwoven layer in FIG. 5.

FIG. 9 is a high-resolution TEM image of the LiCoO₂ nanoparticles formed after pyrolysis.

FIG. 10 is an x-ray spectrum of the nanoparticles of LiCoO₂ formed after pyrolysis of the nonwoven layer in FIG. 5, exhibiting excellent crystallinity and no amorphous content.

FIGS. 11A, 11B, 12, and 13A-13D are SEM images of fiber samples prepares in Example 2.

FIG. 14A is an SEM image of a cathode assembly prepared in Example 5.

FIG. 14B is a plot of measured discharge capacity of coin cells with half-cell configuration using the cathode assemblies of Example 5.

FIG. 14C is a plot of measured coulombic efficiencies of coin cells with half-cell configuration using the cathode assemblies of Example 5.

### DEFINITIONS

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, the terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The term “solidity” is used here to refer to the relative amount of solid material in a fibrous material and may be calculated as:

$$c = \frac{{m}_{f}}{{ρ}_{f} At} = \frac{bw}{{ρ}_{f} t} ,$$

where c is solidity, mf is mass of the fibers, ρ_{f} is the density of the fiber, A is the area of the fibrous material, t is the layer thickness of the fibrous material, and bw is basis weight of the fibrous material. The relationship between solidity and porosity is % porosity+% solidity=100%.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Any direction referred to here, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

The term “particle size” refers to the largest dimension of each particle in a representative sample of a plurality of particles. Particle size may be measured using transmission electron microscopy and/or scanning electron microscopy. The measured size for each particle corresponds to a sphere that would pass through the same size sieve aperture if the sample of interest was being sieved. When a particle size range is given, 70 wt-% or greater, 80 wt-% or greater, 90 wt-% or greater, or 95 wt-% or greater of the nanoparticles have a particle size within the range.

### DETAILED DESCRIPTION

The present disclosure relates to nanomaterials for various applications. In particular, the present disclosure relates to nanomaterials for use in electrochemical and chemical reactions. In particular, the present disclosure relates to nonwoven material compositions and methods of making and using the same. The present disclosure further relates to nanoparticle compositions and methods of making and using the same.

According to embodiments of the present disclosure, nanoparticles may be prepared from salts by electrospinning with a sacrificial polymer. Nanoparticles made by the methods of the present disclosure may exhibit a narrow distribution in nanoparticle size, as measured by the average diameter of the nanoparticle. The nanoparticles may have few to no dislocations or other crystalline deformations. The method described in the present disclosure is highly scalable and compatible with many salts and polymer matrices. Other benefits not listed here may also exist.

According to an embodiment, a sacrificial nonwoven material is synthesized via electrospinning a solution of a sacrificial polymer, at least two ion species of at least one salt, and a solvent. The sacrificial polymer provides a fiber-forming component to form a fiber that is contained in the sacrificial nonwoven material. The fiber includes the sacrificial polymer and the at least two ion species. The at least two ion species are adhered to the polymer. The at least two ion species are distributed across the fiber. According to some embodiments, the sacrificial nonwoven material is subjected to a decomposition treatment. The decomposition treatment decomposes at least a portion of the sacrificial nonwoven material resulting in a plurality of nanoparticles. Each nanoparticle includes a plurality of at least one compound species. The compound species is a reaction product of the at least two ion species. In some embodiments, the compound species may be a reaction product of the at least two ion species and an additional compound or ion species. In some embodiments, the compound species and/or nanoparticles are electroactive. In some embodiments, the compound species and/or nanoparticles are catalytically active.

According to some embodiments, a nonwoven layer is produced via spinning (e.g., electrospinning) a solution of a binder polymer and nanoparticles onto a substrate. The binder polymer provides the fiber-forming component to create a fiber. The nanoparticles are adhered to the binder polymer. The nanoparticles are distributed across the fiber. In some embodiments, the nanoparticles are provided by electrospinning a solution of sacrificial polymer, at least two ions of at least one salt, and a solvent, followed by a decomposition treatment.

According to embodiments of the present disclosure, the nanoparticles may be incorporated into nonwoven layer nanomaterials. In some embodiments, the nanoparticle containing nanomaterials may be used in an electrode assembly, such as in a battery. The electrode assembly made by the method described in the present disclosure may provide a large electrode/electrolyte interfacial area for enhanced electrochemical oxidation/reduction kinetics. The electrode assembly may provide a controllable inter-fiber void volume that allows for sufficient electrolyte infiltration into the electrode. The electrode assembly may provide a high nanoparticle content and short lithium-ion transport pathways. Other benefits not listed here may also exist.

According to an embodiment, the nonwoven layer contains a plurality of nanoparticles. Each nanoparticle includes a plurality of at least one electroactive compound species. In some embodiments, the nonwoven layer is spun (e.g., electrospun) onto a substrate that is a current collector, thus creating an electrode assembly. In some embodiments the electrode assembly is a cathode assembly. In some embodiments, the electrode assembly is an anode assembly. In some embodiments, the cathode assembly may be used in a battery, such as a lithium-ion battery. In some embodiments, the anode assembly may be used in a battery, such as a lithium-ion battery. In some embodiments, the cathode assembly and the anode assembly may be used in a battery, such as a lithium-ion battery.

According to embodiment of the present disclosure, the nanoparticles may include at least one catalytically active compound species. In some embodiments, a catalyst assembly is produced by electrospinning nanoparticles and binder polymer to create a nonwoven layer. In some embodiments, the nonwoven layer is deposited onto a substrate. In some embodiments, the catalyst assembly does not include the substrate.

According to embodiments of the present disclosure, the nanoparticles may be incorporated into nonwoven materials. In some embodiments, the nanoparticle-containing materials may be used in catalytic assemblies. The electrode catalytic assemblies made by the method described in the present disclosure may provide a nonwoven layer that allows for dispersion of the nanoparticles with minimal aggregating, therefore increasing the surface area of each nanoparticle for the catalytically active compound to catalyze a reaction. The increased surface area of the catalyst may be economically and environmentally friendly as less of the catalyst compound may be necessary to perform the desired reaction. The nonwoven layer may also provide a support for the catalyst. Other benefits not listed here may also exist.

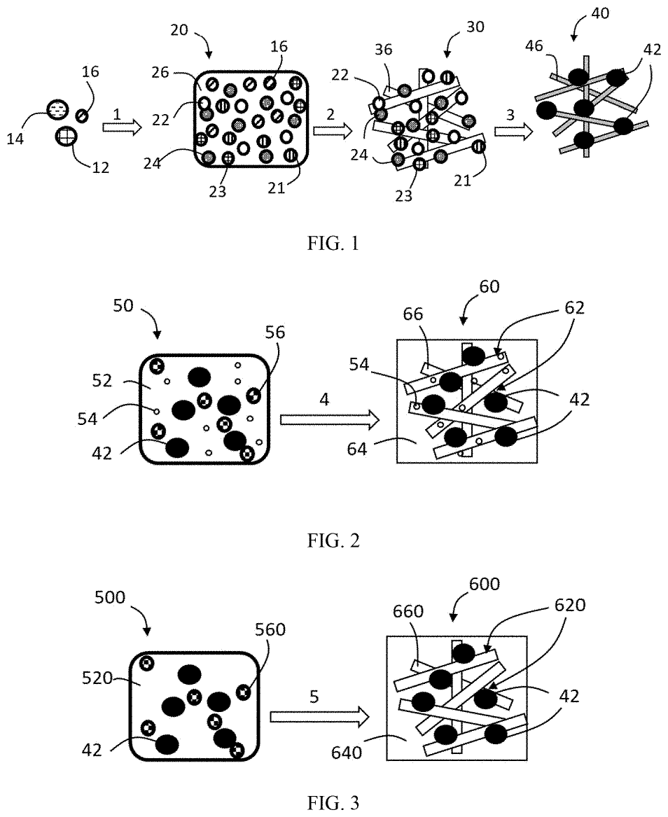

Referring now to FIG. 1, the general process for making the nanoparticles according to an embodiment of the present disclosure is shown. At least one salt 12 and a sacrificial polymer 16 are dissolved (arrow 1) to create the solution 20. In some embodiments, one salt or multiple salts, such as two salts, three salts, four salts, five salts, six salts, seven salts, eight salts, nine salts, or ten or more salts may be dissolved in solution 20. In the exemplary embodiment shown in FIG. 1, an optional second salt 14 is dissolved in the solution 20. The solution 20 includes at least a first ion species and a second ion species of the at least one salt. For example, in some embodiments, as depicted in FIG. 1, the solution 20 includes a first ion species 22 from the first salt 12, a second ion species 24 from the first salt 12, the sacrificial polymer 16, and a solvent 26. In some embodiments where one or more additional optional salts are dissolved in solution 20, solution 20 includes one or more additional ion species. For example, in some embodiments as depicted in FIG. 1, solution 20 includes a third ion species 21 from the optional second salt 14 and a fourth ion species 23 from the second salt 14. A sacrificial nonwoven material 30 is created through the process of spinning (e.g., electrospinning) (arrow 2) the solution 20. The sacrificial nonwoven material 30 includes a fiber 36. The sacrificial polymer 16 provides the fiber-forming component of the fiber 36. Therefore, the fiber 36 includes the sacrificial polymer 16, as well the first ion species 22 and the second ion species 24. The first ion species 22 and the second ion species 24 are adhered to the polymer. The first ion species 22 and the second ion species 24 are distributed along the fiber 36. In some embodiments, where one or more optional additional salts are dissolved in solution, the one or more additional ion species from the optional salt are adhered to the fiber 36. In some embodiments, where one or more optional additional salts are dissolved in solution, the one or more additional ion species from the one or more optional salts are distributed across fiber 36. For example, in some embodiments, as depicted in FIG. 1, the third ion species 21 from the second salt 14 and the fourth ion species 23 from the second salt 14 are adhered to the polymer. The third ion species 21 and the fourth ion species 23 are distributed along the fiber 36. The sacrificial nonwoven material 30 is exposed to a decomposition treatment 3 resulting in a blend 40. The blend 40 includes a plurality of nanoparticles 42. The blend 40 may include decomposed or partially decomposed fibers 46. Each nanoparticle of the plurality of nanoparticles 42 include a plurality of at least one compound species. The compound species is the reaction product between at least the first ion species 22 and the second ion species 24.

The first ion species 22 and the second ion species 24 result from the dissolution of the at least one salt in the solution 20. In some embodiments, the first ion species 22 and the second ion species 24 results from the dissolution of two or more different salts in the solution 20. In some embodiment as illustrated in FIG. 1, the first ion species 22 and the second ion species 24 result from the dissolution of the first salt 12. In some embodiments, when an optional additional salt is dissolved in solution 20, additional ion species result from the dissolution of the additional salts. For example, in FIG. 1, the third ion species 21 and the fourth ion species 23 result from the dissolution of the second salt 14 in solution 20. In some embodiments, the first salt 12 is LiNO₃. In some embodiments, the solution 20 includes the first ion species 22, Li⁺ and the second ion species 24, NO₃⁻ from the dissolution of the first salt 12, LiNO₃. In some embodiments, the third ion species 21 and the fourth ion species 24 result from the dissolution of one or more additional salts, such as the second salt 14 depicted in FIG. 1. In some embodiments, the second salt 14 is Co(NO₃)₂. Thus, the solution 20 includes the third ion species Co²⁺ and additional NO₃⁻ ions from the dissolution of the optional second salt 14, Co(NO₃)₂. Optional additional ion species may be present in solution 20. The additional ion species may be from the optional salts added to solution 20 in addition to the at least one salt or ions present in the solvent 26, for example, ion species present in water.

Each nanoparticle 42 in the plurality of nanoparticle includes a plurality of at least one at compound species. The compound species is the reaction product between at least the first ion species 22 and the second ion species 24. In some embodiments, where the nanoparticles 42 include at least one compound species that is electroactive, the at least one salt and optional additional salts may be any combination of salts that dissolve into ion species capable of reacting to form an electroactive compound species. Additional reactive species may participate in the reaction. Additional reactive species may be a part of the reaction product. Examples of additional reactive species include oxygen, sulfur, phosphorous, nitrogen, and any combination thereof.

According to an embodiment, the compound species is electroactive. In some embodiments, the electroactive compound species is a cathode active compound. In some embodiments, the electroactive compound species includes lithium. In some embodiments, the electroactive compound species includes lithium and one or more metals. Examples of cathode active electroactive compound species include LiCoO₂, LiFePO₄, LiMn₂O₄, LiNiO₂, Li(NiₓMn_{y}Co_{z})O₂, and Li(NiₓAl_{y}Co_{z})O₂, where x+y+z=1. In some embodiments, the cathode electroactive compound species is LiCoO₂. In some embodiments, the cathode active electroactive compound species is LiNiO₂. Examples of salts that may dissolve to produce ion species that are capable of reacting to form a cathode active electroactive compound species include, but are not limited to, LiNO₃, Co(NO₃)₂, Ni(NO₃)₂, Fe(NO₃)₂, Mn(NO₃)₂, Al(NO₃)₃, Li₂SO₄, CoSO₄, NiSO₄, FeSO₄, MnSO₄, Al₂(SO₄)₃, Li(CH₃COO), Co(CH₃COO)₂, Ni(CH₃COO)₂, Fe(CH₃COO)₂, Fe₃O(CH₃COO)₂, Mn(CH₃OO)₂, AlOH(CH₃COO)₂, Al₃(CH₃COO)₃, LiH₂PO₄, Co₃(PO₄)₂, Ni₃(PO₄)₂, FePO₄, Mn₃(PO₄)₂, AlPO₄, H₃PO₄, triethylphosphate (CH₃CH₂)₃PO₄, Ni(NO₃)₂, Co(NO₃)₂, Mn(NO₃)₂, Al(NO₃)₃, Fe(NO₃)₂, LiNO₃, LiH₂PO₄, Fe(CH₃COO)₂, NiSO₄, CoSO₄, Li₂SO₄, MnSO₄, FeSO₄, Al₂(SO₄)₃, Al(OCH₃)₃, Al(CH₃COO)₃, and hydrates thereof. In some embodiments, the first salt 12 is LiNO₃ and the second salt 14 is Co(NO₃)₂·6H₂O. In some embodiments, the first salt 12 is LiNO₃ and the second salt 14 is Ni(NO₃)₂·6H₂O. In some embodiments, each nanoparticle in the plurality of nanoparticles 42 may include two or more electroactive compound species that are cathode active compounds. For example, in some embodiments, the nanoparticles may include LiCoO₂ and LiNiO₂.

In some embodiments, the electroactive compound species is an anode active compound species. Examples of anode electroactive compound species include Co₃O₄, Cu₂O, Li₄Ti₅O₁₂ (lithium titanate), SiO₂, Fe₂O₃, Al₃Ni, CuCo₂O₄, PdNiBi, TiO, Sn₄P₃, NiO, carbides thereof, and any combination thereof. Examples of metallic anode materials include Li metal and alkaline earth metals such as Mg or Ca, as well as Si based compounds. The Si based compounds may be int the form of Si fibers. Further examples of anode electroactive species include LiAl alloys, LiSi alloys, LiBi alloys, LiCd alloys, AlMg alloys, LiMg alloys, LiSn alloys, LiSb alloys, FeSn alloys, SnSb alloys, SnCu alloys, LiGe alloys, LiPb alloys, oxides thereof, sulfides thereof, phosphides thereof, carbides thereof, nitrides thereof, and any combination thereof. The molecular formula of an anode electroactive compound species may not reflect the empirical formula. Additional examples of anode electroactive species include nitrides, oxides, carbides, of metallic or semi-metallic elements including Li, Co, Pd, Pt, W, Mo, Zr, Fe, Al, Ni, Ti, Sn, and combinations thereof. In some embodiments, the anode electroactive compound species is silicon. In some embodiments, the electroactive compound species is silicon, and the silicon is in silicon fiber configuration. In some embodiments, the anode electroactive compound species is Li₄Ti₅O₁₂. Examples of salts that may dissolve to produce ion species that are capable of reacting to form an anode active electroactive compound species include, but are not limited to, K₂TiO₃, NaKTiO₃, Na₄Ti₅O₁₂, LiNO₃, LiH₂PO₄, H₂TiO₃, H₄Ti₅O₁₂, H₂TiO₅, Co(NO₃)₂, Ni(NO₃)₂, Fe(NO₃)₂, Mn(NO₃)₂, Al(NO₃)₃, Li₂SO₄, CoSo₄, NiSO₄, FeSO₄, MnSO₄, Al₂(SO₄)₃, Li(CH₃COO), Co(CH₃COO)₂, Ni(CH₃COO)₂, Fe(CH₃COO)₂, Fe₃O(CH₃COO)₂, Mn(CH₃OO)₂, AlOH(CH₃COO)₂, Al₃(CH₃COO)₃, Li(PO₄), Co₃(PO₄)₂, Ni₃(PO₄)₂, FePO₄, Mn₃(PO₄)₂, AlPO₄, PdSO₄, Pd(NO₃)₂, Pd(CH₃COO)₂, PtSO₄, Pt(NO₃)₂, Pt(CH₃COO)₂, Pt(SO₄)₃, Bi(NO₃)₃, Bi(CH₃OO)₃, Ti(SO₄)₂, Ti(NO₃)₄, Ti(CH₃COO)₄, SnSO₄, Sn(NO₃)₂, Sn(CH₃COO)₂, MgSO₄, Mg(NO₃)₂, Mg(CH₃COO)₂, W(SO₄)₅, W(NO₃)₆, W(CH₃COO)₄, Ge(SO₄)₂, Ge(NO₃)₄, Ge(CH₃COO)₄, PbSO₄, Pb(NO₃)₂, Pb(CH₃COO)₂, Zr(SO₄)₂, Zr(NO₃)₄, Zr(CH₃COO)₄, Mo(SO₄)₂, Mo(CH₃COO)₄, Mg(NO₃)₂, Mg(CH₃COO)₂, Ca(NO₃)₂, Ca(CH₃COO)₂, and hydrates thereof. In some embodiments, the first salt 12 is H₂TiO₃ and the second salt 14 is Li(CH₃COO). In some embodiments, the first salt 12 is H₂TiO₅ and the second salt 14 is Li₂SO₄. In some embodiments, the nanoparticles 42 may include two or more electroactive compound species that are anode active compound species. For example, in some embodiments, the nanoparticles may include Li₄Ti₅O₁₂ and Si based compounds.

In some embodiments, where the nanoparticles 42 include at least one compound that is catalytically active, the at least one salt and optional additional salts may be any combination of salts that dissolve into ions species capable of reacting to form a catalytically active compound species. Additional reactive species may participate in the reaction to form the catalytically active compound. Additional reactive species may be a part of the reaction product of the catalytically active compound. Additional reactive species that may be a part of the reaction product include oxygen, sulfur, phosphorous, nitrogen, and any combination thereof. Catalytically active compounds may be multi-metallic. Multi-metallic catalytically active compounds have two or more metals. Multi-metallic catalysts are of interest due to their increased catalytic activity. Multi-metallic catalysts may include noble metals and non-noble metals. Noble metal-based catalysts include the elements of Ru, Rh, Pd, Os, Ir, Pt, and Au. Noble metals are rare, and as such are costly, but noble metals have a high catalytic efficiency. A means of reducing the cost of noble metal-based catalysts is to increase the surface to volume ratio of the nanoparticles containing the catalytically active compounds (e.g., making the nanoparticles smaller). Non-noble metal-based catalysts may include, for example, one or more of the elements Cr, Mn, Fe, Co, Ni, Cu, Zn, or any transition metal, lanthanide, or actinide that is not a noble metal. Multi-metallic catalysts may contain one or more noble metals, one or more non-noble metals, or a mixture of noble and non-noble metals. In some embodiments, the nanoparticles 42 include a hybrid of noble and non-noble metal based catalytically active compounds. Hybrids of noble and non-noble metal-based catalyst may be used to reduce cost. The catalytically active compound species of the present disclosure may be multi-metallic compounds. The molecular formula of a catalytically active compound species may not reflect the empirical formula. Examples of catalytically active multi-metallic compounds include PbSe, AuPt, AuPd, PtPd, PtRu, PtAg, PtCu, FeRu, FeCu, FeRh, CuCe, AuCu, PtIr, NiCu, NiSn, NiAl, PtAl₂, PtMg, PtSn, PtCo, PdCo, PdTi, PtRh, NiAu, RhAg, PdCuCe, oxides thereof, sulfides thereof, and phosphides thereof. Catalytically active compounds may also include only a single metal. The catalytically active compound species of the present disclosure may include only a single metal. Nonlimiting examples of catalytically active compound that contain a single metal include, ZnO, ZnP, Ni₂P, NiS, NiCo, NiCu, ZnO, NiO, Cu, AuPt, AuPd, TiO₂, and NiO. In some embodiments, the catalytically active compound species is TiO₂, NiCo, NiCu, ZnO, NiO, Cu, AuPt, AuPd.

Examples of salts that may dissolve into ion species that are capable of reacting to form catalytically active compound species include, but are not limited to, TiCl₃, Ti(CH₃COO)₂, TiOSO₄, Ti(NO₃)₄, (NH₄)AuCl₄, NaAuBr, HAuCl₄, KCl, KAuCl₄, Na₂PdCl₄, K₂PdBr₄, PdCl₆, K₂PdCl₆, (NH₄)₂PdCl₄, K₂PdCl₄, Na₂PtCl₄, K₂PtBr₄, PtCl₆, K₂PtCl₄, (NH₄)₂PtCl₄, K₂Pt(NO₂)₄, KAg(CN)₂, KCu, Ni(NO₃)₂, Mg(NO₃)₂, NiCl₂, PdCl₂, Ni(CH₃COO)₂, NiBr₂, NiI₂, NiSO₄, Pb(CH₃COO)₂, SeCl₂, Se(CH₃COO)₂, SeBr₄, ZnSO₄, Zn(CH₃COO)₂, Zn(NO₃)₂, ZnCl₂, FeCl₂, FeSO₄, Fe(NO₃)₂, RuCl₃, Ru(NO₃)₃, RhCl₃, Rh(NO₃)₃, IrCl₄, Ir₂(SO₄)₃, CuCl₂, Cu(NO₃)₂, CuSO₄, Cu(CH₃COO)₂, SnCl₄, Sn(CH₃COO)₂, SnSO₄, Sn(NO₃)₄, AlCl₃, Al₂(SO₄)₃, Al(NO₃)₃, MgCl₂, MgSO₄, CoCl₂, Co(CH₃COO)₂, CoSO₄, Co(NO₃)₂, Mn(NO₃)₂, LiNO₃, LiH₂PO₄, Fe(CH₃COO)₂, Li₂SO₄, MnSO₄, Al(OCH₃)₃, Al(CH₃COO)₃, and any combination thereof. In some embodiments, one or more organic precursors containing the metal of interest may be used. For example, titanium isopropoxide, Ti[OCH(CH₃)₂]₄ may be used as a precursor to from the catalyst TiO₂. In some embodiments, the first salt 12 is NiCl₂, Ni(CH₃COO)₂, ZnSO₄, Zn(CH₃COO)₂, KCl, or KAuCl₄. In some embodiments, the second salt 14 is CoCl₂, Co(CH₃COO)₂, CuCl₂, Cu(NO₃)₂, PdCl₆, K₂PdCl₆, Na₂PtCl₄, or K₂PtBr₄.

In some embodiments additional reagents may be added to the solution 20. Examples of additional reagents include, dopants, stabilizing reagents, and reducing reagents. Examples of reducing reagents include, but are not limited to, tetrabutylammonium borohydride, tetraethylammonium borohydride, tetramethylammonium borohydride, sodium borohydride, sodium triacetoxyborohydride, sodium cyanoborohydride, sodium dihydrido(2-methoxyethoxy)aluminate, potassium borohydride, potassium triethylborohydride, aluminum borohydride, zinc borohydride, ammonium borohydride, lithium aluminum hydride, and hydrazine. Examples of dopants include, but are not limited to, binary heteroatoms, ternary heteroatoms, alkali metals, transition metals, carbon powder, and combinations thereof. Examples of stabilizing reagents include, but are not limited to, SiO₂ particles, detergents, and organic ligands. In some embodiments, the organic ligands may be bound to the metal in the catalytically active compound species.

The sacrificial polymer 16 is generally selected to be at least partially decomposable. Suitable decomposition treatment examples include, for example, thermal degradation, thermal oxidation, enzymatic digestion, thermo-mechanical degradation, chemical degradation, photodegradation, and any combination thereof. Examples of the sacrificial polymer include polyhydrocarbons, including polyethylene, polypropylene, polystyrene, polyacetylene, and combinations thereof; halopolyhydrocarbons including poly(vinyl)chloride, polyvinylidene fluoride, poly(tetrafluoroethylene), and combinations thereof; polyamides, including nylon-6, nylon-6,6, nylon-6,10, nylon-11, nylon-12, para-aramid, carbamide-methanal, melamine-methanal, and combinations thereof; polysulfones including poly(arylene sulfone), poly(bisphenol-A sulfone), polyethersulfone, polyphenylenesulfone, polysulfone, and combinations thereof; polyethers including polyethylene glycol, polyetheretherketone, poly(ethylene)oxide, polyvinyl butyral, polycaprolactone, and combinations thereof; polyesters including polyethylene terephthalate, poly(glycolic acid), poly-L-lactic acid, polydioxanone, and combinations thereof; polyamines including polyaniline; polyalcohols, including fluoropolyalcohols; polyurethanes; polyacrylates, including poly(methylmethacrylate), and polymethyl methacrylate; polycarbonates; polyaromatics, including polyethylene dioxythiophene, polyisothianapthene, polypyrrole, and combinations thereof; photosensitive polymers; other polymers including polyvinylpyrrolidone, polyvinylacetate, cellulose acetates, and polyacrylonitrile; copolymers thereof; block polymers thereof; and combinations thereof. In some embodiments, the sacrificial polymer 16 is or includes a copolymer of styrene butadiene. In some embodiments, the sacrificial polymer 16 is or includes polyvinylpyrrolidone. In some embodiments, the sacrificial polymer 16 is or includes a terpolymer of nylon-6; nylon-6,6; and nylon-6,10. The terpolymer may include, for example, from 40 wt-% to 50 wt-% (e.g., 45 wt-%) of nylon-6; from 15 wt-% to 25 wt-% (e.g., 20 wt-%) of nylon 6,6; and from 20 wt-% to 30 wt % (e.g., 25 wt-%) of nylon-6,10. In some embodiments, the sacrificial polymer 16 is or includes polyvinyl alcohol. In some embodiments, the sacrificial polymer 16 is or includes polyethylene glycol. The sacrificial polymer 16 may have various topologies including linear and branched. In some embodiments, more than one sacrificial polymer may be used.

The molecular weight of the sacrificial polymer 16 may be chosen to be compatible with the electrospinning process 2. Generally, higher molecular weight polymers are associated with increased chain entanglement which may result in a solution 20 with a higher viscosity than a solution 20 that includes lower molecular weight polymers. The viscosity of the solution 20 that is being subjected to electrospinning impacts fiber formation. For example, solutions with low viscosities may result in discontinuous fiber formation or electro spraying. Solutions with a viscosity that are too high may result in clogged electrospinning machinery and/or beading and discontinuous fiber formation. Depending on the polymer of choice (chemical structure and molecular weight), solutions suitable for electrospinning may have viscosities from 20 cP to 1000 cP as measured at room temperature. The viscosity may be measured using a viscometer (e.g., Brookfield LV DV-I Prime Viscometer available from AMETEK Brookfield at Middleboro, Mass.) at a set temperature, for example 25° C. In some embodiments, the solution 20 has a viscosity of 20 cP or greater, 50 cP or greater, 100 cP or greater, 200 cP or greater, or 500 cP or greater. The solution may have a viscosity of 1000 cP or less, 800 cP or less, or 600 cP or less.

Additionally, the molecular weight of the sacrificial polymer 16 may impact the average diameter of the fiber. In general, higher molecular weight polymers result in a fiber with a larger average diameter than a fiber formed with a lower molecular weight polymer.

In some embodiments, the mass average molecular weight of the sacrificial polymer 16 is 15,000 g/mol or greater, 25,000 g/mol or greater, 50,000 g/mol or greater, 100,000 g/mol or greater, 250,000 g/mol or greater, 500,000 g/mol or greater, 750,000 g/mol or greater, 1,000,000 g/mol or greater, or 1,500,000 g/mol or greater. In some embodiments, mass average molecular weight of the sacrificial polymer 16 is 25,000 g/mol or less, 50,000 g/mol or less, 100,000 g/mol or less, 250,000 g/mol or less, 500,000 g/mol or less, 1,000,000 g/mol or less, or 1,500,000 g/mol or less. In some embodiments, the mass average molecular weight of the sacrificial polymer 16 is 15,000 g/mol to 1,500,000 g/mol, 15,000 g/mol to 1,000,000 g/mol, 15,000 g/mol to 500,000 g/mol, 15,000 g/mol to 250,000 g/mol, 15,000 g/mol to 100,000 g/mol, 15,000 g/mol to 50,000 g/mol, or 15,000 g/mol to 25,000 g/mol. In some embodiments, mass average molecular weight of the sacrificial polymer 16 is 25,000 g/mol to 1,500,000 g/mol, 25,000 g/mol to 1,000,000 g/mol, 25,000 g/mol to 500,000 g/mol, 25,000 g/mol to 250,000 g/mol, 25,000 g/mol to 100,000 g/mol, or 25,000 g/mol to 50,000 g/mol. In some embodiments, mass average molecular weight of the sacrificial polymer 16 is 50,000 g/mol to 1,500,000 g/mol, 50,000 g/mol to 1,000,000 g/mol, 50,000 g/mol to 500,000 g/mol, 50,000 g/mol to 250,000 g/mol, or 50,000 g/mol to 100,000 g/mol. In some embodiments, the mass average molecular weight of the sacrificial polymer 16 is 100,000 g/mol to 1,500,000 g/mol, 100,000 g/mol to 1,000,000 g/mol, 100,000 g/mol to 500,000 g/mol, or 100,000 g/mol to 250,000 g/mol. In some embodiments, mass average molecular weight of the sacrificial polymer 16 is 250,000 g/mol to 1,500,000 g/mol, 250,000 g/mol to 1,000,000 g/mol, or 250,000 g/mol to 500,000 g/mol. In some embodiments, mass average molecular weight of the sacrificial polymer 16 is 500,000 g/mol to 1,500,000 g/mol, or 500,000 g/mol to 1,000,000 g/mol. In some embodiments, the mass average molecular weight of the sacrificial polymer 16 is 1,000,000 g/mol to 1,500,000 g/mol. In some embodiments, more than one sacrificial polymer may be used, and the different sacrificial polymers may have different mass average molecular weights.

The dispersity of the molecular weight of the sacrificial polymer 16 may affect the character of fiber 36. The molecular weight dispersity may be quantified as the dispersity (Ð_{M}). Ð_{M} is the distribution of individual molecular masses of a polymer. Ð_{M} is calculated as the quotient of the mass average molecular weight (M_{w}) divided by the number-average molecular weight (Mₙ). The M_{w} and Mₙ may be determined using various methods including viscometry, size exclusion chromatography, and mass spectrometry. Generally, a small Ð_{M} is preferred. Electrospinning a polymer with a large Ð_{M} may result in an inconsistent fiber average diameter or droplet formation. Although there is no desired lower limit, in practice the Ð_{M} of the sacrificial polymer 16 may be 1.0 or greater, 1.1 or greater, 1.2 or greater, 1.3 or greater, 1.4 or greater, or 1.8 or greater. In some embodiments, the Ð_{M} of the sacrificial polymer 16 may be 2.0 or less, 1.8 or less, 1.4 or less, 1.3 or less, 1.2 or less, or 1.1 or less. In some embodiments, the Ð_{M} for the sacrificial polymer 16 is 1.0 to 2.0, 1.0 to 1.8, 1.0 to 1.4, 1.0 to 1.3, 1.0 to 1.2, or 1.0 to 1.1. In some embodiments, the Ð_{M} for the sacrificial polymer 16 is 1.1 to 2.0, 1.1 to 1.8, 1.1 to 1.4, 1.1 to 1.3, or 1.1 to 1.2. In some embodiments, the Ð_{M} for the sacrificial polymer 16 is 1.2 to 2.0, 1.2 to 1.8, 1.2 to 1.4, or 1.2 to 1.3. In some embodiments, the Ð_{M} for the sacrificial polymer 16 is 1.3 to 2.0, 1.3 to 1.8, or 1.3 to 1.4. In some embodiments, the Ð_{M} for the sacrificial polymer 16 is 1.4 to 2.0, or 1.4 to 1.8. In some embodiments, the Ð_{M} for the sacrificial polymer 16 is 1.8 to 2.0. In some embodiments, more than one sacrificial polymer may be used, and the different sacrificial polymers may have different Ð_{M} values.

The amount of the sacrificial polymer 16 relative to the amount of the total salts present in the solution 20 may affect the properties of the electrospun fiber 36 and the nanoparticles 42. The term “total salts” includes the amount of the at least one salt and any optional additional salts that may be present in the solution 20. In some embodiments, the weight-% of total salts relative to the weight % of the sacrificial polymer 16 is one part or more, two parts or more, three parts or more, four parts or more, five parts or more, six parts or more, seven parts or more, eight parts or more, or nine parts or more of total salts for every one part of sacrificial polymer. In some embodiments, the weight-% of total salts relative to the weight % of the sacrificial polymer 16 is ten parts or fewer, nine parts or fewer, eight parts or fewer, seven parts or fewer, six parts or fewer, five parts or fewer, four parts or fewer, three parts or fewer, or two parts or fewer of total salts for every one part of sacrificial polymer. In some embodiments, the weight-% of total salts relative to the weight % of the sacrificial polymer 16 is from 1:6 to 2:1, from 1:3 to 5:3, from 2:3 to 5:3, from 2:3 to 4:3, or from 1:3 to 4:3.

The solvent 26 is generally chosen to allow the at least one salt 12 and any optional additional salts to dissociate into their respective ion species as well as to dissolve the sacrificial polymer 16. Additionally, the solvent 26 is generally chosen to be compatible with electrospinning. As such, the solvent 26 may be chosen so that dissolving the sacrificial polymer results in a suitable viscosity for electrospinning the solution 20. The solvent may include one or more protic solvents, aprotic solvents, hydrophobic solvents, hydrophilic solvents, and any combinations thereof. Examples of suitable solvents include but are not limited to, dimethylformamide, isopropanol, ethanol, ether, acetone, carbon tetrachloride, anisole, acetic acid, benzene, dioxane, petroleum ether, acetonitrile, hexane, pyridine, ethyl acetate, cyclohexane, dimethyl sulfoxide, 1,2-dichloroethane, chloroform, xylene, methanol, dichloromethane, tetrahydrofuran, acetonitrile, acetone, N-methyl-2-pyrrolidone, water, benzyl alcohol, toluene, and any combinations thereof. The solvent may be aqueous. To increase the solubility of the salts and the polymer, the pH of the solvent may be adjusted. The pH may be adjusted using an organic acid or base, or an inorganic acid or base. In some embodiments, the solvent is or includes a mixture of isopropanol and dimethylformamide. In some embodiments, the solvent is or includes ethanol. In some embodiments, the solvent is or includes acetone.

The solution 20 is subjected to electrospinning (arrow 2 in FIG. 1) to create a sacrificial nonwoven material 30. Electrospinning is an electrohydrodynamic process used for fine fiber production. Generally, electrospinning is the process of electrifying a solution to form a jet, followed by stretching and elongating of the jet to form a fiber. Depending on the parameters, the process of electrospinning may form one long fiber or many shorter fibers. The solution parameters and processing parameters of the electrospinning method may be tuned to result in a suitable average diameter and composition of the fiber. Solution parameters include the viscosity of solution, the polymer concentration, and the molecular weight of the sacrificial polymer. Processing parameters include conductivity, surface tension, voltage, tip to collector distance, feed rate, type of the collector, motion of the collector, humidity, pressure, and temperature. The processing parameters are dependent on the fiber-forming polymer and the solvent or solvents in solution 20. The voltage applied may affect the fiber properties. Electrospinning conditions typically include voltages of 4 kV to 30 kV. The distance from the target to collector may affect the fiber properties. Electrospinning conditions typically have a target to collector distance of 2 cm to 39 cm. In some embodiments, the sacrificial nonwoven material is deposited onto a rotating cylinder collector. In some embodiments, the sacrificial nonwoven material is deposited onto a stationary collector. In some embodiments, solution 20 may be subjected to traditional electrospinning, co-axial electrospinning, emulsion electrospinning, or malt electrospinning.

The weight-% of the total solids in the solution 20 may affect the properties of the sacrificial nonwoven material 30. The total solids include the first salt, any additional optional salts, any additional ingredients, and the sacrificial polymer. In some embodiments, the weight-% of the total solids in solution 20 is 5% or greater, 10% or greater, 15% or greater, 20% or greater, 30% or greater, or 40% or greater. In some embodiments, the wt-% of the total solids in solution is 50% or less, 40% or less, 30% or less, 20% or less, 15% or less, 10% or less, or 5% or less. In some embodiments, the weight-% of the total solids is 5% to 50%, 5%, to 40%, 5% to 30%, 5% to 20%, 5% to 15%, 5% to 10%, 10% to 50%, 10%, to 40%, 10% to 30%, 10% to 20%, 10% to 15%, 15% to 50%, 15%, to 40%, 15% to 30%, 15% to 2 0%, 20% to 50%, 20%, to 40%, 20% to 30%, 30% to 50%, 30% to 40%, 40% to 50%, 10% to 20%, 20% to 30%. In some embodiments, when the sacrificial polymer is nylon, the total weight-% of the solids is 10% to 25%. In some embodiments, when the sacrificial polymer is cellulose acetate, the weight-% of the total solids in the solution is at least 20% to 30%.

The sacrificial nonwoven material 30 includes the fiber 36. The fiber 36 may be a single fiber or a plurality of fibers. The sacrificial polymer 16 is the fiber-forming component of the fiber 36. Thus, the fiber 36 includes the sacrificial polymer 16, as well as the first ion species 22 and the second ion species 24. The first ion species 22 and the second ion species 24 are adhered to the polymer 16 and across the fiber 36. Examples of adhering forces include metal-ligand interactions, electrostatic attractions, pi-pi stacking, and combinations thereof. In some embodiments the first ion species 22 and second ion species 24 are evenly dispersed across the fiber 36. Each fiber 36 has an average diameter. The average diameter may be measured using various techniques including scanning electron microscopy or transmission electron microscopy. In some cases, the fiber may be characterized as a nanofiber. However, the fibers of the present disclosure are not necessarily limited to sub-micron diameter fibers. In some embodiments, the fiber 36 has an average diameter of 5 μm or less, 4 μm or less, 3 μm or less, 2 μm or less, 1.5 μm or less, of 1.2 μm or less, 1.0 μm of less, 0.8 μm or less, 0.6 μm or less, 0.4 μm or less, or 0.2 μm or less. In some embodiments, the fiber 36 has an average diameter of 0.1 μm or greater, 0.2 μm or greater, 0.4 μm or greater, 0.5 μm or greater, 0.6 μm or greater, 0.8 μm or greater, 1.0 μm or greater, or 1.2 μm or greater. In some embodiments the fiber 36 has an average diameter of 0.1 μm to 5 μm, 0.1 μm to 4 μm, 0.1 μm to 3 μm, 0.1 μm to 2 μm, 0.5 μm to 5 μm, 0.5 μm to 4 μm, 0.5 μm to 3 μm, 0.5 μm to 2 μm, 0.8 μm to 5 μm, 0.8 μm to 4 μm, 0.8 μm to 3 μm, 0.8 μm to 2 μm, 1 μm to 5 μm, 1 μm to 4 μm, 1 μm to 3 μm, 0.1 μm to 1.5 μm, 0.2 μm to 1.5 μm, 0.4 μm to 1.5 μm, 0.6 μm to 1.5 μm, 0.8 μm to 1.5 μm, 1.0 μm to 1.5 μm, or 1.2 μm to 1.5 μm. In some embodiments the fiber 36 has an average diameter of 0.1 μm to 1.2 μm, 0.2 μm to 1.2 μm, 0.4 μm to 1.2 μm, 0.6 μm to 1.2 μm, 0.8 μm to 1.2 μm, or 1.0 μm to 1.2 μm. In some embodiments the fiber 36 has an average diameter of 0.1 μm to 1.0 μm, 0.2 μm to 1.0 μm, 0.4 μm to 1.0 μm, 0.6 μm to 1.0 μm, or 0.8 μm to 1.0 μm. In some embodiments the fiber 36 has an average diameter of 0.1 μm to 0.8 μm, 0.2 μm to 0.8 μm, 0.4 μm to 0.8 μm, or 0.6 μm to 0.8 μm.

In some embodiments, the smaller the average diameter of the fiber 36, the smaller the size of the nanoparticles 42 formed after the decomposition treatment 3. Generally, fibers with smaller average diameters are associated with the formation of smaller nanoparticles 42. In some embodiments, the smaller the average diameter of the fiber the less energy (e.g., thermal energy) is necessary for the decomposition treatment 3.

Sacrificial nonwoven material 30 is subjected to a decomposition treatment (arrow 3) resulting in blend 40. The blend 40 includes the plurality of nanoparticles 42. The blend 40 may include decomposed or partially decomposed fibers 46. The decomposition treatment 3 may promote a chemical reaction between at least the first ion species 22 and second ion species 24 resulting in at least one compound species. In some embodiments, additional species may be a part of the reaction product. Examples of additional reactive species include oxygen, sulfur, phosphorous, nitrogen, and combinations thereof. The nanoparticles 42 are formed from a plurality of the compound species assembling in a crystalline structure. In some embodiments, the compound species is electroactive. Examples of suitable electroactive compounds species include LiCoO₂, LiFePO₄, LiMn₂O₄, LiNiO₂, Li(NiₓMn_{y}Co_{z})O₂, and Li(NiₓAl_{y}Co_{z})O₂, where x+y+z=1. In some embodiments the compound species is catalytically active. Examples of suitable catalytically active compounds include to PbSe, AuPt, AuPd, PtPd, PtRu, PtAg, PtCu, FeRu, FeCu, FeRh, CuCe, AuCu, PtIr, NiCu, NiSn, NiAl, PtAl₂, PtMg, PtSn, PtCo, PdCo, PdTi, PtRh, NiAu, RhAg, PdCuCe and oxides, sulfides, and phosphides thereof.

In some embodiments, the nanoparticles 42 have a narrow particle size distribution. In some embodiments, the nanoparticles 42 have a particle size range of 0.005 μm to 0.5 μm, 0.005 μm to 0.4 μm, 0.005 μm to 0.3 μm, 0.005 μm to 0.2 μm, 0.005 μm to 0.1 μm, 0.005 μm to 0.05 μm, 0.005 μm to 0.05 μm, 0.005 μm to 0.04 μm, 0.005 μm to 0.03 μm, 0.005 μm to 0.02 μm, or 0.005 μm to 0.01 μm. In some embodiments, the nanoparticles 42 have a particle size range of 0.01 μm to 0.5 μm, 0.01 μm to 0.4 μm, 0.01 μm to 0.3 μm, 0.01 μm to 0.2 μm, 0.01 μm to 0.1 μm, 0.01 μm to 0.05 μm, 0.01 μm to 0.04 μm, 0.01 μm to 0.03 μm, or 0.01 μm to 0.02 μm. In some embodiments, the nanoparticles 42 have a particle size range of 0.02 μm to 0.5 μm, 0.02 μm to 0.4 μm, 0.02 μm to 0.3 μm, 0.02 μm to 0.2 μm, 0.02 μm to 0.1 μm, 0.02 μm to 0.05 μm, 0.02 μm to 0.04 μm, or 0.02 μm to 0.03. In some embodiments, the nanoparticles 42 have a particle size range of 0.03 μm to 0.5 μm, 0.03 μm to 0.4 μm, 0.03 μm to 0.3 μm, 0.03 μm to 0.2 μm, 0.03 μm to 0.1 μm, 0.03 μm to 0.05 μm, or 0.03 μm to 0.04 μm. In some embodiments, the nanoparticles 42 have a particle size range of 0.04 μm to 0.5 μm, 0.04 μm to 0.4 μm, 0.04 μm to 0.3 μm, 0.04 μm to 0.2 μm, 0.04 μm to 0.1 μm, or 0.04 μm to 0.05 μm. In some embodiments, the nanoparticles 42 have a particle size range of 0.05 μm to 0.5 μm, 0.05 μm to 0.4 μm, 0.05 μm to 0.3 μm, 0.05 μm to 0.2 μm, or 0.05 μm to 0.1 μm. In some embodiments, the nanoparticles 42 have a particle size range of 0.1 μm to 0.5 μm, 0.1 μm to 0.4 μm, 0.1 μm to 0.3 μm, or 0.1 μm to 0.2 μm. In some embodiments, the nanoparticles 42 have a particle size range of 0.2 μm to 0.5 μm, 0.2 μm to 0.4 μm, or 0.2 μm to 0.3 μm. In some embodiments, the nanoparticles 42 have a particle size range of 0.3 μm to 0.5 μm or 0.3 μm to 0.4 μm. In some embodiments, the nanoparticles 42 have a particle size range of 0.4 μm to 0.5 μm.

The decomposition treatment 3 is generally chosen to decompose at least a portion of the sacrificial nonwoven material 30. The sacrificial nonwoven material 30 includes the fiber 36. The fiber includes the first ion species 22 and the second ion species 24. The decomposition treatment results in a mass difference between the sacrificial nonwoven material 30 and the blend 40. The blend 40 includes the plurality of nanoparticles. The blend 40 may include decomposed or partially decomposed fiber 36. The extent of decomposition may be characterized as the difference in mass between the sacrificial nonwoven material 30 and the blend 40. Decomposition of the sacrificial polymer may contribute to the mass change. Decomposition of the first salt and the second salt may contribute to the mass change. The extent of decomposition can be measured as the quotient between the initial total mass of the sacrificial polymer and salts added to the solution 20 and the mass of the blend 40. In some embodiments, the decomposition treatment 3 decomposes 25% or greater, 50% or greater, or 75% or greater of the sacrificial nonwoven material 30. In some embodiments, the decomposition treatment 3 decomposes 99% or less, 95% or less, 90% or less, 75% or less, 50% or less, or 25% or less of the nonwoven material 30. In some embodiments, the decomposition treatment 3 may decompose 25% to 99%, 25% to 95%, 25% to 90%, 25% to 75%, 25% to 50%, or 25% to 50% of the sacrificial nonwoven material 30. In some embodiments, the decomposition treatment 3 may decompose 50% to 99%, 50% to 95%, 50% to 90%, or 50% of the sacrificial nonwoven material 30. In some embodiments, the decomposition treatment 3 may decompose 75% to 99%, 75% to 95%, or 75% to 90% of the sacrificial nonwoven material 30. In some embodiments, the decomposition treatment 3 may decompose 90% to 99% or 90% to 95% of the sacrificial nonwoven material 30. In some embodiments, the decomposition treatment 3 may decompose 95% to 99% of the sacrificial nonwoven material 30.

The decomposition treatment 3 is generally chosen to decompose at least a portion of the fiber 36 by decomposing at least a portion of the sacrificial polymer 16 resulting in decomposed fiber 46. Suitable decomposition treatment examples include, thermal degradation, thermal oxidation, enzymatic digestion, thermo-mechanical degradation, chemical degradation, photodegradation, and any combination thereof. In some embodiments, the blend 40 is subjected to a post-decomposition processing. An example of a post-decomposition process is sieving blend 40 to separate at least a portion of the nanoparticles from the decomposed fiber 36. In some embodiments, the nanoparticles of a certain size range may be isolated from blend 40 via filtering.

In some embodiments, the decomposition treatment 3 includes thermal degradation in the form of pyrolysis. Pyrolysis is the thermal decomposition of a material at high temperatures in an inert atmosphere (e.g., little to no oxygen). In some embodiments, gases such as oxygen may be added during pyrolysis to encourage combustion of fiber 36. In some embodiments, the decomposition treatment 3 includes pyrolysis at a temperature of 400° C. or greater, 500° C. or greater, at least 600° C. or greater, at least 700° C. or greater, or 800° C. or greater. In some embodiments, decomposition treatment 3 includes pyrolysis at a temperature 500° C. or less, 600° C. or less, 700° C. or less, no 800° C. or less, 900° C. or less, no 1000° C. or less, or 1100° C. or less. In some embodiments, decomposition treatment 3 includes pyrolysis at a temperature effective to decompose the sacrificial polymer to a desired extent, such as 400° C. to 1100° C., 400° C. to 1000° C., 400° C. to 900° C., 400° C. to 800° C., 400° C. to 700° C., 400° C. to 600° C., 400° C. to 700° C., 500° C. to 1100° C., 500° C. to 1000° C., 500° C. to 900° C., 500° C. to 800° C., 500° C. to 700° C., or 500° C. to 600° C. In some embodiments, the temperature of pyrolysis may be changed throughout the pyrolysis process.

In some embodiments, the pyrolysis treatment creates an artificial solid electrolyte interface in the form of a carbonaceous layer around individual nanoparticles. Transmission electron microscopy may be used to measure the thickness of the carbonaceous layer. In some embodiments, the thickness of the carbonaceous layer is 10 nm or less, 5 nm or less, 2 nm or less, or 1 nm or less. In some embodiments, the thickness of the carbonaceous layer is 1 nm or greater, 2 nm or greater, or 5 nm or greater. In some embodiments, the carbonaceous layer is 1 nm to 10 nm, 1 nm to 5 nm, or 1 nm to 2 nm thick. In some embodiments, the carbonaceous layer is 2 nm to 10 nm or 2 nm to 5 nm thick. In some embodiments, the carbonaceous layer is 5 nm to 10 nm thick. The carbonaceous layer may not impede the diffusion of lithium ions into and out of the crystalline lattice of the electroactive nanoparticles. In some embodiments, the artificial solid electrolyte interface may improve battery life by decreasing capacity fade.

In some embodiments, pyrolysis includes carbonization of the fiber 36 resulting in decomposed fiber 46 that is elemental carbon. In some embodiments, the fiber 36 is partially pyrolyzed resulting in a decomposed fiber 46 that includes carbon, sacrificial polymer 16, and lower molecular weight polymers formed by breaking various bonds in the sacrificial polymer 16 during the pyrolysis process. Incomplete pyrolysis may be beneficial as the remaining polymer and lower molecular weight polymers may serve as a passive layer in an electrode assembly. Incomplete pyrolysis of the fiber 36 may be beneficial as the remaining polymer and lower molecular weight polymers may serve as a support in a catalyst assembly.

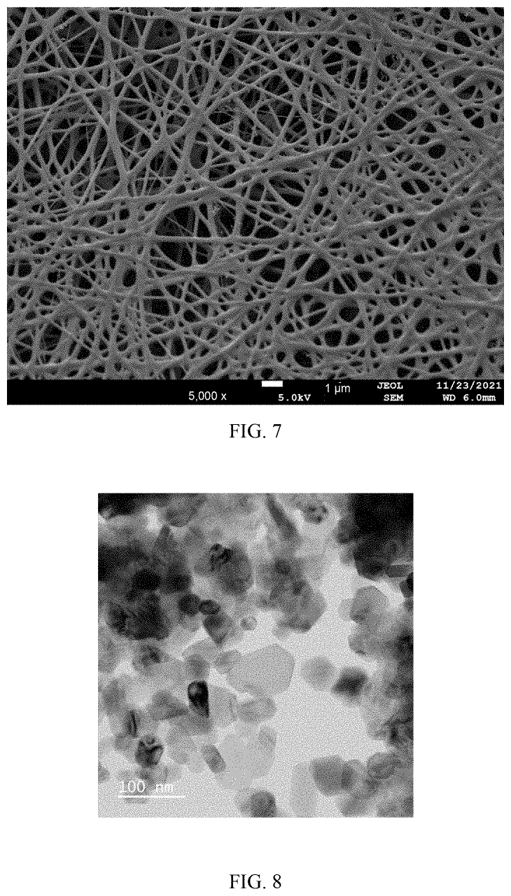

Without wishing to be bound by theory, it is believed that the nanoscale anisotropy of the fibers made by the methods of the present disclosure allows the conversion of the ion species into electroactive nanoparticles at pyrolysis temperatures as low as 550° C. to produce highly crystalline nanoparticles (e.g., see FIG. 7). In contrast, many other protocols for making electroactive materials require temperatures higher than 700° C. The decrease in pyrolysis temperature compared to other protocols may lead to energy and financial savings. According to an embodiment, the electroactive nanoparticles of the present disclosure are highly stable. For example, in some embodiments, the cathode electroactive nanoparticles of the present disclosure are stable after more than 100 cycles of charging and discharging. The methods of the present disclosure for making the nanoparticles may also allow a decrease in the number of steps used to apply an artificial solid electrolyte interface to the nanoparticles. For example, many protocols apply the artificial solid electrolyte interface as an independent, post-treatment step using atomic layer deposition, molecular layer deposition, chemical vapor deposition, or via sol-gel methods. In contrast, in some embodiments of the present disclosure, the pyrolysis decomposition treatment allows for in situ formation of an artificial solid electrolyte interface in the from thin layer of carbon on the nanoparticles.

The process of the present disclosure may be used to prepare a composition. According to an embodiment, the composition includes an electrospun nonwoven layer. The electrospun nonwoven layer may include a substrate and a fiber deposited onto the substrate by electrospinning. The fiber may be made up of a polymer; and a plurality of nanoparticles dispersed on the polymer and distributed across the fiber. The plurality of nanoparticles may have a particle size range from 0.01 μm to 0.5 μm. Each nanoparticle may include a plurality of at least one compound species. In some embodiment, the composition is used to make an electrode assembly.

According to an embodiment, the composition includes a substrate and two fiber layers deposited onto the substrate by electrospinning. The fiber layers may include fibers made up of a polymer and a plurality of nanoparticles dispersed on the polymer and distributed across the fiber. Each fiber layer may have a different solidity, where one layer has at least 1.1 times higher solidity than the other layer. In some embodiments, the layer with higher solidity is deposited first adjacent the substrate, and the layer with lower solidity is deposited after onto the first layer. The plurality of nanoparticles may have a particle size range from 0.01 μm to 0.5 μm. Each nanoparticle may include a plurality of at least one compound species. In some embodiment, the composition is used to make an electrode assembly.

According to an embodiment, the composition includes an electrospun nonwoven layer that includes a substrate and a fiber layer deposited onto the substrate by electrospinning. The fiber layer may include fibers, each fiber having a fiber diameter of from 0.1 μm up to 5 μm. The fibers may include a polymer and a plurality of nanoparticles dispersed on the polymer and distributed across the fiber. The plurality of nanoparticles may have a particle size range from 0.01 μm to 0.5 μm. Each nanoparticle may include a plurality of at least one compound species. In some embodiments, the composition is used to make an electrode assembly.

FIG. 2 shows a schematic of a process used to make an electrode assembly 60. In some embodiments, the electrode assembly 60 is a cathode assembly. In some embodiments, the electrode assembly 60 is an anode assembly. Solution 50 is spun (e.g., electrospun) 4 onto a substrate 64 producing a nonwoven layer 62. The solution 50 includes nanoparticles 42 that include a compound species that is electroactive, a conductive material 54, and a binder polymer 56, all dissolved in a solvent 52. The electroactive compound may include any electroactive compound species or a combination of electroactive compound species. Examples of cathode electroactive compound species include LiCoO₂, LiFePO₄, LiMn₂O₄, LiNiO₂, Li(NiₓMn_{y}Co_{z})O₂, and Li(NiₓAl_{y}Co_{z})O₂, where x+y+z=1. Examples of anode active electroactive compound species include Co₃O₄, Cu₂O, Li₄Ti₅O₁₂ (lithium titanate), SiO₂, Fe₂O₃, Al₃Ni, CuCo₂O₄, PdNiBi, TiO, Sn₄P₃, NiO and carbides therefore, and combinations thereof. Further examples of anode electroactive species include LiAl alloys, LiSi alloys, LiBi alloys, LiCd alloys, AlMg alloys, LiMg alloys, LiSn alloys, LiSb alloys, FeSn alloys, SnSb alloys, SnCu alloys, LiGe alloys, LiPb alloys, oxides thereof, sulfides thereof, phosphides thereof, carbides thereof, nitrides thereof, and combinations thereof. Additional examples of anode active electroactive species include nitrides, oxides, carbides, of metallic or semi-metallic elements including Li, Co, Pd, Pt, W, Mo, Zr, Fe, Al, Ni, Ti, Sn, and combinations thereof. In some embodiments, the nanoparticles 42 may have been prepared using the process described in reference to FIG. 1.

The solution 50 is subjected to electrospinning 4 to create nonwoven layer 62. Nonwoven layer 62 includes a fiber 66. The binder polymer 56 is the fiber-forming component of the fiber 66. Thus, the fiber 66 includes the binder polymer 56. The conductive material 54 and the nanoparticles 42 are bound to the binder polymer 56 and distributed along the fiber 66. In some embodiments, the conductive material 54 and the nanoparticles 42 are evenly distributed along the fiber 66. In some embodiments, the fiber 66 is a single fiber. In some embodiments, the fiber 66 is a plurality of fibers. Any electrospinning method discussed in reference to the process described in FIG. 1 may be used.

In some embodiments, the nanoparticles 42 have a narrow particle size distribution. The nanoparticles may have any particle size range disclosed elsewhere herein. The solvent 52 may be chosen to allow for dispersion, preferably a homogenous dispersion, of the nanoparticles 42 and conductive material 54, as well as dissolving binder polymer 56. The solvent 52 may be chosen to minimize the dissolution of nanoparticles 42 into component ions. The solvent 52 is preferably chosen to be compatible with the electrospinning process. Suitable solvents include protic solvents, aprotic solvents, hydrophobic solvents, hydrophilic solvents, and any combinations thereof. Examples of suitable solvents include but are not limited to, dimethylformamide, isopropanol, ethanol, ether, acetone, carbon tetrachloride, anisole, acetic acid, benzene, dioxane, petroleum ether, acetonitrile, hexane, pyridine, ethyl acetate, cyclohexane, dimethyl sulfoxide, 1,2-dichloroethane, chloroform, xylene, methanol, dichloromethane, tetrahydrofuran, acetonitrile, acetone, N-methyl-2-pyrrolidone, water, benzyl alcohol, toluene, and any combinations thereof. The solvent may be aqueous. To decrease the solubility of the nanoparticles the pH of the solvent may be adjusted. To increase the solubility of the binder polymer, the pH may be adjusted. The pH may be adjusted using an organic acid or base, or an inorganic acid or base.

The binder polymer 56 is generally selected to bind the nanoparticles 42 and the conductive material 54. The binder polymer itself may be conductive. Examples of binder polymers include polyhydrocarbons, including polyethylene, polypropylene, polystyrene, polyacetylene, and the like; halopolyhydrocarbons including poly(vinyl)chloride, polyvinylidene fluoride, and poly(tetrafluoroethylene); polyamides, including nylon-6, nylon-6,6, nylon-6,10, nylon-11, nylon-12, para-aramid, carbamide-methanal, melamine-methanal, and the like; polysulfones including poly(arylene sulfone), poly(bisphenol-A sulfone), polyether sulfone, polyphenylenesulfone, and polysulfone; polyethers including polyethylene glycol, polyether ether ketone, poly(ethylene)oxide, polyether sulfone, and the like; polyesters including polyethylene terephthalate, poly(glycolic acid), poly-L-lactic acid, poly-L-lactic acid, polydioxanone, and the like; polyamines including polyaniline, and the like; polyalcohols, including fluoropolyalcohols; polyurethanes; polycarbonates, polyaromatics, including polyethylene dioxythiophene, polyisothianapthene, polypyrrole, poly(3-hexylthiophene), and the like; polyimide; photosensitive polymers; other polymers including polyacrylates, polyvinylpyrrolidone; and copolymers of block polymers, for example, styrene butadiene, and the like; copolymers thereof; block polymers thereof; and combinations thereof. In some embodiments, the binder polymer 56 is a styrene butadiene copolymer. In some embodiments, the binder polymer 56 is polyvinylidene difluoride.

For the electrode assembly 60, the substrate 64 may be chosen to be a current collector. The electrode assembly may be compatible with materials and types of current collectors known in the art. For example, the substrate 64 may contain one or more materials able to collect current, such as Cu, Al, Ni, Ti, Pt, stainless steel, carbon, or any combination thereof. The current collector material may be in the form of a foil, mesh, foam, woven layer, or a nonwoven layer. In some embodiments, the substrate includes Cu foil, Al foil, Pt foil, or Ni foil. The current collector material may coat a surface of an additional substrate. The current collector may be an artificial dual solid-electrolyte interface. In some embodiments, post-electrospinning treatments such as known mechanical and/or chemical processes may be used to adhere the nonwoven layer 62 to the substrate 64.

The conductive material 54 may be chosen to increase the electronic and ionic conductivity of the electrode assembly 60. Any suitable conductive material known in the art may be used. Examples of suitable conductive materials include, but are not limited to, carbon powder, carbon fiber, graphite, carbon nanotubes, graphene, graphyne, bronze, copper, tungsten, carbon steel, silver, gold, aluminum, zinc, INCONEL (available from American Special Metals, Corp. in Miami, Fla.), HASTELLOY (available from Hastelloy International Corporation in Tipton, Ind.), KOVAR (available from CRS Holdings Inc in Oklahoma City, Okla.), and combinations thereof.

Without wishing to be bound by theory, it is believed that electrode assemblies created by the methods of the present disclosure result in a nonwoven layer 62 that has a large electrode/electrolyte interfacial area allowing for enhanced electrochemical oxidation and reduction kinetics when compared to traditional slurry cast electrodes. Additionally, the use of electrospinning to produce the nonwoven layer 62 may allow for the tunability of the interfiber void volume which may allow good electrolyte infiltration into the electrode. Furthermore, the sub-micrometer fiber 66 may allow for dispersion of the nanoparticles 42 with minimal aggregation. Also, the sub-micrometer fiber 66 may have a high nanoparticle content which may allow for short lithium-ion transport pathways. Additionally, the methods of the present disclosure may be widely adaptable to a wide selection of nanoparticle species and polymer combinations.

The electrode assembly may be used in a battery. Battery types include, but are not limited to, alkaline, aluminum-air, atomic, bunsen, grove, mercury, molten salt, nickel oxyhydroxide, organic radical, silver oxide, zinc oxide, zinc-carbon, zinc-chloride, aluminum-ion, calcium, vanadium redox, zinc-bromine, zinc-cerium, lead-acid, lithium ion, lithium-metal, magnesium ion, metal-air, nickel-cadmium, nickel-hydrogen, nickel iron, nickel-metal hydride, polymer-based, polysulfide-bromide, potassium ion, and zinc ion batteries. In some embodiments, the cathode assembly is used in a lithium-ion battery. Lithium-ion batteries include, but are not limited to, lithium-cobalt oxide, lithium-silicon, lithium-manganese oxide, lithium-polymer, lithium-nickel-manganese-cobalt oxide, lithium-nickel-cobalt-aluminum oxides, lithium-sulfur, lithium-titanate, and lithium-ceramic batteries.

In some embodiments, the battery is a lithium-ion battery. Examples of cathode electroactive compound species that may be used in a lithium-ion battery cathode assembly are discussed elsewhere herein. Examples of anode electroactive compound species that may be used in a lithium-ion battery anode assembly are discussed elsewhere herein. In some embodiments, at least a portion of the cathode assembly and/or anode assembly is provided as described in the process referencing FIG. 2.

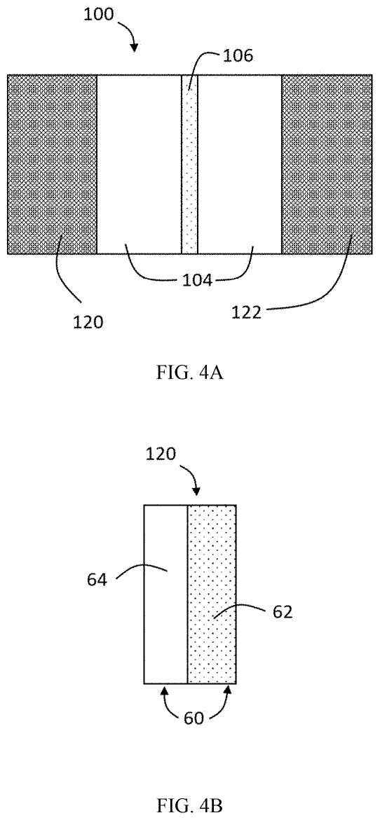

FIG. 4A shows a generic lithium-ion battery 100. The battery 100 has a cathode 120, an anode 122, an electrolyte 104, and a separator 106. Any suitable electrolyte 104 may be used including, for example, a polymer electrolyte, or a liquid electrolyte. Examples of electrolytes include solutions of LiPF₆ (lithium hexafluorophosphate), LiBF₄ (lithium tetrafluoroborate), LiClO₄ (lithium perchlorate), and any combination thereof. The electrolyte solutions may be prepared in one or more organic solvents. Examples of organic solvents include carbonate organic solvents including dimethyl carbonate, ethyl methyl carbonate, diethyl carbonate, propylene carbonate; and other organic solvents including acetonitrile; and any combination thereof. Any suitable separator 106 may be used including, for example, polymeric porous membranes such as polyethylene, polypropylene (CELGARD); modified polymeric membranes with thin oxide coatings of titania (TiO₂), zinc oxide (ZnO), and silica (SiO₂); and hybrid organic-organic assemblies such as those that contain SiO₂ nanoparticles covalently tethered within a polymeric network such as polyurethanes, polyacrylates, and polyethylene glycol. In some embodiments, more than one separator may be used.

In some embodiments, the cathode 120 and/or the anode 122 includes the electrode assembly 60. The electrode assembly 60 includes nonwoven layer 62 which is deposited on top of the substrate 64 (FIG. 4B). In some embodiments, the electrode assembly 60 is included at the cathode 120. In some embodiments, the electrode assembly 60 is included at the anode 122. In some embodiments, the electrode assembly 60 is included at the cathode 120 and at the anode 122.

FIG. 3 shows a schematic view of a process used to make a catalyst assembly 600. Solution 500 is spun (e.g., electrospun; arrow 5) onto a substrate 640 producing a nonwoven layer 620. The solution 500 includes nanoparticles 42 and a binder polymer 560 dissolved in a solvent 520. The nanoparticles 42 may include any catalytically active compound species. Examples of catalytically active compound species are discussed elsewhere herein. In an exemplary embodiment, the nanoparticles 42 may have been prepared using the process described with regard to FIG. 1.

In some embodiments, the nanoparticles 42 have a narrow particle size distribution. The nanoparticles 42 may have any particle size range as disclosed elsewhere herein.

The binder polymer 560 is generally chosen to bind the nanoparticles 42. The binder polymer 560 may be any binder polymer discussed in reference to binder polymer 56.

The solvent 520 may be chosen to allow for dispersion, preferably a homogenous dispersion, of the nanoparticles 42 as well as dissolving binder polymer 560. The solvent 520 may be chosen to reduce or minimize the dissolution of nanoparticles 42 into component ions. The solvent 520 may be any solvent discussed in reference to solvent 52.

The solution 500 is subjected to electrospinning 5 to create nonwoven layer 620. Nonwoven layer 620 includes a fiber 42. The binder polymer 560 is the fiber-forming component of the fiber 660. Thus, the fiber 660 includes the binder polymer 560. The nanoparticles 42 are bound to the binder polymer 560 and distributed along the fiber 660. In some embodiments, the nanoparticles 42 are evenly distributed along the fiber 660. In some embodiments, the fiber 660 is a single fiber. In some embodiments, the fiber 660 is a plurality of fibers. Any electrospinning method discussed in reference to the process described in FIG. 1 may be used.

Without wishing to be bound by theory, it is believed that catalyst assemblies created via the methods of the present discloser may allow for a sub-micrometer fiber which may allow for dispersion of the nanoparticles 42 with minimal aggregation. The minimal aggregation of the nanoparticles may allow for the increase in surface area of the nanoparticle which may enhance the ability of the catalytically active compound species to catalyze reactions. Furthermore, the increased surface area of the catalyst may be economically and environmentally friendly as less of the catalyst may be necessary to perform the desired reaction. Additionally, in some embodiments, the fiber 660 may provide a support for the catalyst which may allow for greater catalytic turnover and stability.

For the catalyst assembly 600, substrate 640 is generally chosen to support the nonwoven layer 620. The substrate 640 may provide physical support for nonwoven layer 620. Substrates that provide physical support include, but are not limited to, metals, papers, and plastics. The substrate material may be chosen to avoid altering the catalytic activity of the compounds in the nanoparticles. Examples of substrate materials that may not affect the reactivity of a catalyst are silicon dioxide, aluminum dioxide, and ceramic containing materials. The substrate material may be chosen to promote the catalytic activity of the compounds in the nanoparticles. Examples of substrates that may promote the catalytic activity of the compounds in the nanoparticles include, but are not limited to, carbon nanotubes and other carbon structures. The substrate 640 may be a single layer or multiple layers. Each layer of a multiple layer substrate may be made of a different material. For example, for a two-layer substrate, the layer that is in contact with nonwoven layer 620 may include silicon dioxide and the layer that is not in contact with the nonwoven layer may be a metal. In some embodiments, the nonwoven layer may be adhered to the substrate 640 using known mechanical and/or chemical methods.

The catalyst assembly 600 may be used to catalyze reactions. A suitable amount of the catalyst assembly may be exposed to reagents to catalyze a chemical transformation of one or more of the reagents. For example, a catalyst assembly 600 that includes nanoparticles made of PtPdO may be used to catalyze methane combustion. In another example, a catalyst assembly 600 that includes nanoparticles made of NiO may be used to catalyze the coupling reaction of an aldehyde, an amine, and an alkyne to give a propargylamine. In yet another example, a catalyst assembly 600 may include nanoparticles made of CuNi, CuCo, or CuFe, or a combination thereof, may be used to catalyze the partial oxidation of propylene to acrolein.

In some embodiments, the nonwoven layer 620 may be removed from the substrate 640 and used as a catalyst. In this embodiment, the binder polymer provides support for the nanoparticles.

### SPECIFIC EMBODIMENTS

A non-exhaustive listing of non-limiting exemplary aspects is provided below. Any one or more of the features of these aspects may be combined with any one or more features of another example, embodiment, or aspect described herein.

### Embodiments A. Composition

According to embodiment 1A, a composition comprises an electrospun nonwoven material comprising: a fiber having an average diameter of less than 5 μm comprising: a sacrificial polymer present at 40 weight-% to 60 weight-% of a total weight of the electrospun nonwoven material; and a first ion species and a second ion species dispersed on the sacrificial polymer and distributed along the fiber, the first ion species and the second ion species being ion specie of at least one salt, the at least one salt being present at 60 weight-% or less of a weight-% of a total salt, the weight-% of the total salt relative to a weight-% of the sacrificial polymer is 1 part or more of the total salt weight-% to every 6 parts of the sacrificial polymer weight-%.

Embodiment 2A is the composition of embodiment 1A, wherein the at least one salt comprises NiCl₂, Ni(CH₃COO)₂, ZnSO₄, Zn(CH₃COO)₂, KCl, KAuCl₄, CoCl₂, Co(CH₃COO)₂, CuCl₂, Cu(NO₃)₂, PdCl₆, K₂PdCl₆, Na₂PtCl₄, K₂PtBr₄, Ni(NO₃)₂, Co(NO₃)₂, Mn(NO₃)₂, Al(NO₃)₃, Fe(NO₃)₂, LiNO₃, LiH₂PO₄, Fe(CH₃COO)₂, NiSO₄, CoSO₄, Li₂SO₄, MnSO₄, FeSO₄, Al₂(SO₄)₃, Al(OCH₃)₃, Al(CH₃COO)₃, or a combination thereof.

Embodiment 3A is the composition of any one of the preceding embodiments, wherein the sacrificial polymer is polyvinylpyrrolidone, polyethyleneglycol, nylon, polyurethane, polyvinyl alcohol, polyvinylacetate, polyacrylonitrile, polyacrylate, or a combination thereof. In some embodiments, the sacrificial polymer comprises one or more polyamides, polysulfones, polyethers, polyesters, polyamines, polyalcohols, polyurethanes, polycarbonates, polyaromatics, photosensitive polymers, polyimides, or a combination thereof.

Embodiment 4A is the composition of any one of the preceding embodiments, wherein the weight-% of the total salt relative to the weight-% of sacrificial polymer is from 1:6 to 2:1, from 1:3 to 5:3, from 2:3 to 5:3, from 2:3 to 4:3, or from 1:3 to 4:3.

Embodiment 5A is the composition of any one of the preceding embodiments, wherein the fiber has an average diameter of 4 μm or less, 3 μm or less, 2 μm or less, 1.5 μm or less, or 1 μm or less.

Embodiment 6A is the composition of any one of the preceding embodiments, wherein the at least one compound species is electroactive.

Embodiment 7A is the composition of embodiment 6A, wherein the at least one compound species comprises LiCoO₂, LiFePO₄, LiMn₂O₄, LiNiO₂, Li(NiₓMn_{y}Co_{z})O₂, Li(NiₓAl_{y}Co_{z})O₂, or a combination thereof, wherein x+y+z=1. In some embodiments, the at least one compound species comprises Co₃O₄, Cu₂O, Li₄Ti₅O₁₂, SiO₂, Fe₂O₃, Al₃Ni, CuCo₂O₄, PdNiBi, TiO, Sn₄P₃, NiO, and carbides thereof; LiAl alloys, LiSi alloys, LiBi alloys, LiCd alloys, AlMg alloys, LiMg alloys, LiSn alloys, LiSb alloys, FeSn alloys, SnSb alloys, SnCu alloys, LiGe alloys, LiPb alloys, oxides thereof, sulfides thereof, phosphides thereof, carbides thereof, nitrides thereof; nitrides, oxides, and carbides of Li, Co, Pd, Pt, W, Mo, Zr, Fe, Al, Ni, Ti, Sn; silicon; or a combination thereof.

Embodiment 8A is the composition of any one of the preceding embodiments, wherein the at least one compound species is catalytically active.

Embodiment 9A is the composition of embodiment 8A, wherein the at least one compound species comprises PbSe, AuPt, AuPd, PtPd, PtRu, PtAg, PtCu, FeRu, FeCu, FeRh, CuCe, AuCu, PtIr, NiCu, NiSn, NiAl, PtAl₂, PtMg, PtSn, PtCo, PdCo, PdTi, PtRh, NiAu, RhAg, TiO₂, NiO, or a combination thereof.

Embodiment 10A is a composition comprising: a first plurality of nanoparticles with each nanoparticle comprising a first compound species and a second plurality of nanoparticles with each nanoparticle comprising a second compound species different from a first compound species, the nanoparticles of the first and second pluralities of nanoparticles having a particle size range from 0.01 μm to 0.5 μm.

### Embodiments B. Composition

According to embodiment 1B, a composition comprises an electrospun nonwoven layer comprising: a substrate; and a fiber deposited onto the substrate by electrospinning, the fiber comprising: a polymer; and a plurality of nanoparticles dispersed on the polymer and distributed across the fiber, the plurality of nanoparticles having a particle size range from 0.01 μm to 0.5 μm, each nanoparticle comprising a plurality of at least one compound species.

Embodiment 2B is the composition of embodiment 1B comprising a plurality of the fibers forming a first fiber layer.

Embodiment 3B is the composition of any one of embodiments 1B to 2B, further comprising: a second fiber layer comprising second fibers deposited onto the first fiber by electrospinning; the second fibers comprising: a second polymer; and a second plurality of nanoparticles dispersed on the second polymer and distributed across the fiber, the second plurality of nanoparticles having a particle size range from 0.1 μm to 0.5 μm, each nanoparticle comprising a plurality of at least one compound species, wherein the first fiber layer has a solidity that is at least 1.1 times of a solidity of the second fiber layer.

Embodiment 4B is the composition of any one of embodiments 1B to 3B, wherein the fiber has an average diameter of 5 μm or less, 4 μm or less, 3 μm or less, 2 μm or less, 1.5 μm or less, 1.0 μm of less, 0.8 μm or less, 0.6 μm or less, 0.4 μm or less, or 0.2 μm or less. In some embodiments, the fiber has an average diameter of at least 0.1 μm, at least 0.2 μm, at least 0.4 μm, at least 0.5 μm, at least 0.6 μm, at least 0.8 μm, at least 1.0 μm, at least 1.2 μm. In some embodiments the fiber 36 has an average diameter of 0.1 μm to 5 μm, 0.1 μm to 4 μm, 0.1 μm to 3 μm, 0.1 μm to 2 μm, 0.5 μm to 5 μm, 0.5 μm to 4 μm, 0.5 μm to 3 μm, 0.5 μm to 2 μm, 0.8 μm to 5 μm, 0.8 μm to 4 μm, 0.8 μm to 3 μm, 0.8 μm to 2 μm, 1 μm to 5 μm, 1 μm to 4 μm, 1 μm to 3 μm, 0.1 μm to 1.5 μm, 0.2 μm to 1.5 μm, 0.4 μm to 1.5 μm, 0.6 μm to 1.5 μm, 0.8 μm to 1.5 μm, 1.0 μm to 1.5 μm, or 1.2 μm to 1.5 μm.

Embodiment 5B is the composition of any one of embodiments 1B to 4B, wherein the polymer is a binder polymer.

Embodiment 6B is the composition of any one of embodiments 1B to 5B, wherein the polymer comprises one or more polyamides, polysulfones, polyethers, polyesters, polyamines, polyalcohols, polyurethanes, polycarbonates, polyaromatics, photosensitive polymers, polyimides, polyacrylates, polyvinylidenedifluoride, or a combination thereof.

Embodiment 7B is the composition of any one of embodiments 1B to 6B, wherein the electrospun nonwoven layer further comprises a conductive material.

Embodiment 8B is the composition of embodiment 7B, wherein the conductive material is a carbon powder.

Embodiment 9B is the composition of any one of embodiments 1B to 7B, wherein the substrate is a current collector.

Embodiment 10B is the composition of embodiment 9B, wherein the substrate comprises Cu foil, Al foil, Pt foil, Ni foil, a woven substrate, a nonwoven substrate, an artificial solid electrolyte interface, or a combination thereof.

Embodiment 11B is the composition of any one of embodiments 1B to 10B, wherein the substrate comprises silicon dioxide, aluminum dioxide, ceramic, or combinations thereof.

Embodiment 12B is the composition of any one of embodiments 1B to 11B, wherein the at least one compound species is electroactive.

Embodiment 13B is the composition of embodiment 12B, wherein the at least one compound species comprises LiCoO₂, LiFePO₄, LiMn₂O₄, LiNiO₂, Li(NiₓMn_{y}Co_{z})O₂, Li(NiₓAl_{y}Co_{z})O₂, or a combination thereof, wherein x+y+z=1. In some embodiments, the at least one compound species comprises Co₃O₄, Cu₂O, Li₄Ti₅O₁₂, SiO₂, Fe₂O₃, Al₃Ni, CuCo₂O₄, PdNiBi, TiO, Sn₄P₃, NiO, and carbides thereof. LiAl alloys, LiSi alloys, LiBi alloys, LiCd alloys, AlMg alloys, LiMg alloys, LiSn alloys, LiSb alloys, FeSn alloys, SnSb alloys, SnCu alloys, LiGe alloys, LiPb alloys, oxides thereof, sulfides thereof, phosphides thereof, carbides thereof, nitrides thereof; nitrides, oxides, and carbides of Li, Co, Pd, Pt, W, Mo, Zr, Fe, Al, Ni, Ti, Sn; silicon; or a combination thereof.

Embodiment 14B is the composition of any one of embodiments 1B to 13B, wherein the at least one compound species is catalytically active.

Embodiment 15B is the composition of embodiment 14B, wherein the at least one compound species comprises PbSe, AuPt, AuPd, PtPd, PtRu, PtAg, PtCu, FeRu, FeCu, FeRh, CuCe, AuCu, PtIr, NiCu, NiSn, NiAl, PtAl₂, PtMg, PtSn, PtCo, PdCo, PdTi, PtRh, NiAu, RhAg, TiO₂, NiO, or a combination thereof. In some embodiments, the at least one compound species comprises ZnO, ZnP, Ni₂P, NiS, NiCo, NiCu, ZnO, NiO, Cu, AuPt, AuPd, TiO₂, NiO, or a combination thereof.

Embodiment 16B is the composition of embodiment 1B, wherein the plurality of nanoparticles is a first plurality of nanoparticles with each nanoparticle comprising a first compound species, the composition further comprising a second plurality of nanoparticles with each nanoparticle comprising a second compound species different from the first compound species.

### Embodiments C. Battery

Embodiment C1 is a battery comprising: an electrode comprising the composition of any one of Embodiments A or B.

Embodiment C2 is a battery comprising: an electrode comprising a plurality of nanoparticles, each nanoparticle comprising a plurality of at least one electroactive compound species, the plurality of nanoparticles having a particle size range from 0.01 μm to 0.5 μm.

Embodiment C3 is the battery of embodiment C1 or C2 comprising: wherein the electrode comprises: an electrospun nonwoven layer comprising a substrate and a fiber deposited onto the substrate by electrospinning, the fiber comprising: a binder polymer; and the plurality of nanoparticles dispersed on the binder polymer and distributed across the fiber.

Embodiment C4 is the battery of any one of embodiments C1 to C3, wherein the plurality of nanoparticles has a particle size range from 0.02 μm to 0.4 μm.

Embodiment C5 is the battery of any one of embodiments C1 to C4, wherein the at least one electroactive compound species comprises LiCoO₂, LiFePO₄, LiMn₂O₄, LiNiO₂, Li(NiₓMn_{y}Co_{z})O₂, and Li(NiₓAl_{y}Co_{z})O₂, where x+y+z=1. In some embodiments, the at least one compound species comprises Co₃O₄, Cu₂O, Li₄Ti₅O₁₂, SiO₂, Fe₂O₃, Al₃Ni, CuCo₂O₄, PdNiBi, TiO, Sn₄P₃, NiO, and carbides thereof. LiAl alloys, LiSi alloys, LiBi alloys, LiCd alloys, AlMg alloys, LiMg alloys, LiSn alloys, LiSb alloys, FeSn alloys, SnSb alloys, SnCu alloys, LiGe alloys, LiPb alloys, oxides thereof, sulfides thereof, phosphides thereof, carbides thereof, nitrides thereof; nitrides, oxides, and carbides of Li, Co, Pd, Pt, W, Mo, Zr, Fe, Al, Ni, Ti, Sn; silicon; or a combination thereof.

Embodiment C6 is the battery of any one of embodiments C1 to C5, wherein the fiber has an average diameter of less than 1.5 μm.

Embodiment C7 is the battery of any one of embodiments C1 to C6, wherein the binder polymer comprises one or more polyamides, polysulfones, polyethers, polyesters, polyamines, polyalcohols, polyurethanes, polycarbonates, polyaromatics, photosensitive polymers, polyimides, or a combination thereof.

Embodiment C8 is the battery of any one of embodiments C1 to C7, wherein the substrate is a current collector.

Embodiment C9 is the battery of embodiment C8, wherein the substrate comprises Cu foil, Al foil, Pt foil, Ni foil, a woven substrate, a nonwoven substrate, an artificial solid electrolyte interface, or a combination thereof.

### Embodiments D. Method

Embodiment D1 is a method comprising: electrospinning a solution onto a substrate, the solution comprising: a binder polymer; a solvent; and a plurality of nanoparticles, each nanoparticle comprising a plurality of at least one compound species, the plurality of nanoparticles having a particle size range from 0.01 μm to 0.5 μm; and producing a nonwoven layer comprising a fiber comprising: the binder polymer; and the plurality of nanoparticles dispersed within the binder polymer and distributed across the fiber.

Embodiment D2 is the method of embodiment D1, wherein the fiber has an average diameter of less than 5 μm.

Embodiment D3 is the method of embodiment D1 or D2, wherein the at least one compound species is electroactive.

Embodiment D4 is the method of any one of embodiments D1 to D3, wherein the at least one compound species comprises LiCoO₂, LiFePO₄, LiMn₂O₄, LiNiO₂, Li(NiₓMn_{y}Co_{z})O₂, and Li(NiₓAl_{y}Co_{z})O₂, where x+y+z=1. In some embodiments, the at least one compound species comprises Co₃O₄, Cu₂O, Li₄Ti₅O₁₂, SiO₂, Fe₂O₃, Al₃Ni, CuCo₂O₄, PdNiBi, TiO, Sn₄P₃, NiO, and carbides thereof; LiAl alloys, LiSi alloys, LiBi alloys, LiCd alloys, AlMg alloys, LiMg alloys, LiSn alloys, LiSb alloys, FeSn alloys, SnSb alloys, SnCu alloys, LiGe alloys, LiPb alloys, oxides thereof, sulfides thereof, phosphides thereof, carbides thereof, nitrides thereof; nitrides, oxides, and carbides of Li, Co, Pd, Pt, W, Mo, Zr, Fe, Al, Ni, Ti, Sn; silicon; or a combination thereof.

Embodiment D5 is the method of any one of embodiments D1 to D4, wherein the at least on compound species is catalytically active.

Embodiment D6 is the method of embodiment D5, wherein the at least one compound species comprises PbSe, AuPt, AuPd, PtPd, PtRu, PtAg, PtCu, FeRu, FeCu, FeRh, CuCe, AuCu, PtIr, NiCu, NiSn, NiAl, PtAl₂, PtMg, PtSn, PtCo, PdCo, PdTi, PtRh, NiAu, RhAg, TiO₂, NiO, or a combination thereof.

Embodiment D7 is a method comprising: dissolving at least one salt and a sacrificial polymer in a solvent creating a solution, the solution comprising: the sacrificial polymer; a first ion species; a second ions species; and the solvent; electrospinning the solution to form a sacrificial nonwoven material comprising: a fiber comprising: the sacrificial polymer; and the first ion species and the second ion species dispersed on the polymer and distributed along the fiber; and decomposing at least a portion of the sacrificial nonwoven material resulting in a plurality of nanoparticles, each nanoparticle comprising a plurality of at least one compound species, the at least one compound species comprising a reaction product of at least the first ion species and the second ion species, the plurality of nanoparticles having a particle size range from 0.02 μm to 0.5 μm.

Embodiment D8 is the method of embodiment D7, further comprising: spinning a mixture onto a substrate, the mixture comprising: a binder polymer; and the plurality of nanoparticles, the electrospinning of the mixture resulting in a second nonwoven layer comprising a second fiber comprising: the binder polymer; and nanoparticles from the plurality of nanoparticles, dispersed within the binder polymer and distributed across the fiber.

Embodiment D9 is the method of embodiment D7 or D8, wherein the at least one salt comprises LiNO₃, LiH₂PO₄, Co(NO₃)₂, Ni(NO₃)₂, Fe(NO₃)₂, Mn(NO₃)₂, Al(NO₃)₃, Li₂SO₄, CoSO₄, NiSO₄, FeSO₄, MnSO₄, Al₂(SO₄)₃, Fe(CH₃COO)₂, Al(OCH₃)₃, Al(CH₃COO)₃, or a combination thereof.

Embodiment D10 is the method of any one of embodiments D1 to D9, wherein the at least one salt comprises (NH₄)AuCl₄, NaAuBr, HAuCl₄, KCl, KAuCl₄, Na₂PdCl₄, K₂PdBr₄, PdCl₆, K₂PdCl₆, (NH₄)₂PDCl₄, K₂PdCl₄, Na₂PtCl₄, K₂PtBr₄, PtCl₆, K₂PtCl₄, (NH₄)₂PtCl₄, K₂Pt(NO₂)₄, KAg(CN)₂, KCu, Ni(NO₃)₂, Mg(NO₃)₂, NiCl₂, PdCl₂, Ni(Ac)₂, NiBr₂, NiI₂, NiSO₄, Pb(CH₃COO)₂, SeCl₂, Se(CH₃COO)₂, SeBr₄, ZnSO₄, Zn(CH₃COO)₂, Zn(NO₃)₂, ZnCl₂, FeCl₂, FeSO₄, Fe(NO₃)₂, RuCl₃, Ru(NO₃)₃, RhCl₃, Rh(NO₃)₃, IrCl₄, Ir₂(SO₄)₃, CuCl₂, Cu(NO₃)₂, CuSO₄, Cu(CH₃COO)₂, SnCl₄, Sn(CH₃COO)₂, SnSO₄, Sn(NO₃)₄, AlCl₃, Al₂(SO₄)₃, Al(NO₃)₃, MgCl₂, MgSO₄, CoCl₂, Co(CH₃COO)₂, CoSO₄, Co(NO₃)₂, or a combination thereof.

Embodiment D11 is the method of any one of embodiments D1 to D10, wherein the sacrificial polymer comprises polyvinylpyrrolidone, polyethylene glycol, polyvinyl alcohol, polyvinylacetate, polyacrylonitrile, polyacrylate, polyamides, polysulfones, polyethers, polyesters, polyamines, polyalcohols, polyurethanes, polycarbonates, polyaromatics, photosensitive polymers, polyimides, or a combination thereof.

Embodiment D12 is the method of any one of embodiments D1 to D11, wherein the at least one compound species is electroactive.

Embodiment D13 is the method of embodiment D12, wherein the at least on compound species comprises LiCoO₂, LiFePO₄, LiMn₂O₄, LiNiO₂, Li(NiₓMn_{y}Co_{z})O₂, Li(NiₓAl_{y}Co_{z})O₂, or a combination thereof, wherein x+y+z=1. In some embodiments, the at least one compound species comprises Co₃O₄, Cu₂O, Li₄Ti₅O₁₂, SiO₂, Fe₂O₃, Al₃Ni, CuCo₂O₄, PdNiBi, TiO, Sn₄P₃, NiO, and carbides thereof; LiAl alloys, LiSi alloys, LiBi alloys, LiCd alloys, AlMg alloys, LiMg alloys, LiSn alloys, LiSb alloys, FeSn alloys, SnSb alloys, SnCu alloys, LiGe alloys, LiPb alloys, oxides thereof, sulfides thereof, phosphides thereof, carbides thereof, nitrides thereof; nitrides, oxides, and carbides of Li, Co, Pd, Pt, W, Mo, Zr, Fe, Al, Ni, Ti, Sn; silicon; or a combination thereof.

Embodiment D14 is the method of any one of embodiments D1 to D13, wherein the at least one compound species is catalytically active.

Embodiment D15 is the method of embodiment D14, wherein the at least one compound species comprises PbSe, AuPt, AuPd, PtPd, PtRu, PtAg, PtCu, FeRu, FeCu, FeRh, CuCe, AuCu, PtIr, NiCu, NiSn, NiAl, PtAl₂, PtMg, PtSn, PtCo, PdCo, PdTi, PtRh, NiAu, RhAg, TiO₂, NiO, or a combination thereof. In some embodiments, the at least on compound species comprises ZnO, ZnP, Ni₂P, NiS, NiCo, NiCu, ZnO, NiO, Cu, AuPt, AuPd, TiO₂, NiO, or a combination thereof.

Embodiment D16 is the method of any one of embodiments D1 to D15, wherein decomposing comprises a heat treatment.

Embodiment D17 is the method of embodiment D16, wherein the heat treatment comprises pyrolysis at 500° C. to 1100° C. In some embodiments, decomposition treatment 3 includes pyrolysis at a temperature effective to decompose the sacrificial polymer to a desired extent, such as 400° C. to 1100° C., 400° C. to 1000° C., 400° C. to 900° C., 400° C. to 800° C., 400° C. to 700° C., 400° C. to 600° C., 400° C. to 700° C., 500° C. to 1100° C., 500° C. to 1000° C., 500° C. to 900° C., 500° C. to 800° C., 500° C. to 700° C., or 500° C. to 600° C.

Embodiment D18 is the method of any one of embodiments D1 to D17, wherein the solvent is selected from isopropanol, ethanol, methanol, dichloromethane, tetrahydrofuran, acetonitrile, acetone, N-methyl-2-pyrrolidone, water, benzyl alcohol, toluene, N,N′-dimethylformamide, acetic acid, formic acid, or a combination thereof.

Embodiment D19 is the method of embodiment D18, wherein the first solvent and the second solvent are each independently selected from isopropanol, ethanol, methanol, dichloromethane, tetrahydrofuran, acetonitrile, acetone, N-methyl-2-pyrrolidone, water, benzyl alcohol, toluene, N,N′-dimethylformamide, acetic acid, formic acid, or a combination thereof.

Embodiment D20 is the method of any one of embodiments D1 to D19, wherein the binder polymer is selected from polyamides, polysulfones, polyethers, polyesters, polyamines, polyalcohols, polyurethanes, polycarbonates, polyaromatics, photosensitive polymers, polyimides, polyvinylacetates, polyacrylonitriles, polyacrylates, polyvinylidenedifluorides, or a combination thereof.

Embodiment D21 is the method of any one of embodiments D1 to D20, wherein the plurality of nanoparticles has a particle size range from 0.02 μm to 0.4 μm.

Embodiment D22 is the method of embodiment D21, wherein the first fiber and the second fiber each independently have an average diameter of less than 5 μm or less, 4 μm or less, 3 μm or less, 2 μm or less, 1.5 μm or less, of 1.2 μm or less, 1.0 μm of less, 0.8 μm or less, 0.6 μm or less, 0.4 μm or less, or 0.2 μm or less. In some embodiments, the first fiber and the second fiber each independently have an average diameter of at least 0.1 μm, at least 0.2 μm, at least 0.4 μm, at least 0.5 μm, at least 0.6 μm, at least 0.8 μm, at least 1.0 μm, at least 1.2 μm. In some embodiments the first fiber and the second fiber each independently have an average diameter of 0.1 μm to 5 μm, 0.1 μm to 4 μm, 0.1 μm to 3 μm, 0.1 μm to 2 μm, 0.5 μm to 5 μm, 0.5 μm to 4 μm, 0.5 μm to 3 μm, 0.5 μm to 2 μm, 0.8 μm to 5 μm, 0.8 μm to 4 μm, 0.8 μm to 3 μm, 0.8 μm to 2 μm, 1 μm to 5 μm, 1 μm to 4 μm, 1 μm to 3 μm, 0.1 μm to 1.5 μm, 0.2 μm to 1.5 μm, 0.4 μm to 1.5 μm, 0.6 μm to 1.5 μm, 0.8 μm to 1.5 μm, 1.0 μm to 1.5 μm, or 1.2 μm to 1.5 μm.

### Embodiment E. Composition

Embodiment E1 is a composition prepared by the method of any one of Embodiments D.

### EXAMPLES

Methods of preparing exemplary nanoparticles and possible uses of such nanoparticles are illustrated by the following examples. It is to be understood that the particular examples, materials, amounts, and procedures are to be interpreted broadly in accordance with the scope and spirit of the present disclosure.

### Example 1

Example 1 describes the process for generating a plurality of nanoparticles, each nanoparticle including an electroactive compound species that is cathode electroactive. Seven solutions were prepared for electrospinning and subsequent heat treatment.

List of Materials Used:

| Material | Source |
|---|---|
| polyvinylpyrrolidone (PVP), | Alfa Aesar in Tewksbury, MA |
| molecular weight 1,300,000 g/mol | |
| polyvinylidene fluoride (PVdF), | Millipore Sigma in Darmstadt, |
| molecular weight 534,000 g/mol | Germany |
| nylon SVP 651, a terpolymer with | Shakespeare Co. in Columbia, SC |
| number average molecular weight | |
| 21,500-24,800 comprising 45% | |
| nylon-6, 20% nylon-6,6 and 25% | |
| nylon-6,10) | |
| N,N-dimethylformamide (DMF) | Alfa Aesar |
| isopropyl alcohol (IPA) | Alfa Aesar |
| acetone | Antylia Scientific in Vernon |
| | Hills, IL |
| lithium nitrate (LiNO₃) | Alfa Aesar |
| nickel(II) nitrate hexahydrate | Alfa Aesar |
| (Ni(NO₃))₂ · 6H₂O) | |
| cobalt(II) nitrate hexahydrate | Alfa Aesar |
| (Co(NO₃)₂ · 6H₂O) | |
| aluminum(III) nitrate nonahydrate | Alfa Aesar |
| (Al(NO₃)₃ · 9H₂O) | |
| manganese(II) nitrate tetrahydrate | Alfa Aesar |
| (Mn(NO₃))₂ · 4H₂O) | |
| TimCal Super C65 Conductive | MTI Corporation in Richmond, CA |
| Carbon Black | |
| spunbond nylon scrim Media Grade | Cerex Advanced Fibers in |
| 23200, basis weight 70 g/m² and | Cantonment, FL |
| solidity 28% | |
| polyvinylidene fluoride (PVdF) | PVdF L7208 from Kureha in Japan |
| molecular weight 630,000 g/mol in | |
| N-methyl-2pyrrolidone | |
| Celgard separator | Celgard, LLC in Charlotte, NC |
| 1M LiPF₆ in 3/7 ethyl carbonate/ethyl | PuriEL Battery Electrolyte R&D |
| methyl carbonate solvent mixture | 326 from SoulBrain in |
| | Northville, MI |

Solution 1. A solution of 5% (w/v) polyvinylpyrrolidone (PVP) and 5% (w/v) total lithium and cobalt nitrates (1:1 Li:Co molar ratio) in a mixed solvent of 1:1 (v/v) isopropyl alcohol (IPA) and N,N-dimethylformamide (DMF) was used as an electrospinning precursor for lithium cobalt oxide (LiCoO₂, LCO) fibers. The precursor solution was prepared by dissolving 0.9577 g lithium nitrate (LiNO₃) and 4.074 g cobalt (II) nitrate hexahydrate (Co(NO₃)₂·6H₂O) in 100 mL of solvent mixture (50 mL IPA and 50 mL DMF). 5.0 g PVP was added slowly to the solution while magnetically stirring to prevent clumping. The precursor solution was stirred overnight at ambient room temperature to completely dissolve the PVP and metal salts.

Solution 2. A solution of 5% (w/v) polyvinylpyrrolidone (PVP) and 5% (w/v) total lithium and nickel nitrates (1:1 Li:Ni molar ratio) in a mixed solvent of 1:1 (v/v) IPA and DMF was used as an electrospinning precursor for lithium cobalt oxide (LiNiO₂, LNO) fibers. The precursor solution was prepared by dissolving 0.9580 g lithium nitrate (LiNO₃) and 4.050 g nickel (II) nitrate hexahydrate (Ni(NO₃)₂·6H₂O) in 100 mL of solvent mixture (50 mL IPA and 50 mL DMF). 5.0 g PVP was added slowly to the solution while magnetically stirring to prevent clumping. The precursor solution was stirred overnight at ambient room temperature to completely dissolve the PVP and metal salts.

Solution 3. A solution of 5% (w/v) nylon SVP 651 and 5% (w/v) total lithium and cobalt nitrates (1:1 Li:Co molar ratio) in ethanol (EtOH, 190 proof) was used as an electrospinning precursor for lithium cobalt oxide (LiCoO₂, LCO) fibers. The precursor solution was prepared by dissolving 0.9577 g lithium nitrate (LiNO₃) and 4.074 g cobalt(II) nitrate hexahydrate (Co(NO₃)₂·6H₂O) in 100 mL of EtOH. 5.0 g SVP 651 was added slowly to the solution while magnetically stirring to prevent clumping. The precursor solution was stirred overnight with heating to 60° C. under reflux conditions to completely dissolve all solids.

Solution 4. A solution of 5% (w/v) nylon SVP 651 and 5% (w/v) total lithium and nickel nitrates (1:1 Li:Ni molar ratio) in ethanol (EtOH, 190 proof) was used as an electrospinning precursor for lithium cobalt oxide (LiNiO₂, LNO) fibers. The precursor solution was prepared by dissolving 0.9580 g lithium nitrate (LiNO₃) and 4.050 g nickel(II) nitrate hexahydrate (Ni(NO₃))₂·6H₂O) in 100 mL of EtOH. 5.0 g SVP 651 was added slowly to the solution while magnetically stirring to prevent clumping. The precursor solution was stirred overnight with heating to 60° C. under reflux conditions to completely dissolve all solids.

Solution 5. A solution of 7.5% (w/v) nylon SVP 651 and 10% (w/v) total lithium, nickel, manganese and cobalt nitrates (1:0.8:0.1:0.1 Li:Ni:Mn:Co molar ratio) in ethanol (EtOH, 190 proof) was used as an electrospinning precursor for lithium nickel manganese cobalt oxide (NMC 811) fibers. The precursor solution was prepared by dissolving 1.941 g lithium nitrate (LiNO₃), 6.540 g nickel(II) nitrate hexahydrate (Ni(NO₃))₂·6H₂O), 0.7054 g manganese(II) nitrate tetrahydrate (Mn(NO₃))₂·4H₂O) and 0.8103 g cobalt(II) nitrate hexahydrate (Co(NO₃)₂·6H₂O) in 100 mL of EtOH. 7.5 g SVP 651 was added slowly to the solution while magnetically stirring to prevent clumping. The precursor solution was stirred overnight with heating to 60° C. under reflux conditions to completely dissolve all solids.

Solution 6. A solution of 7.5% (w/v) nylon SVP 651 and 10% (w/v) total lithium, nickel, cobalt and aluminum nitrates (1:0.8:0.15:0.05 Li:Ni:Co:Al molar ratio) in ethanol (EtOH, 190 proof) was used as an electrospinning precursor for lithium nickel cobalt aluminum oxide (NCA) fibers. The precursor solution was prepared by dissolving 1.8944 g lithium nitrate (LiNO₃), 6.3909 g nickel(II) nitrate hexahydrate (Ni(NO₃))₂·6H₂O), 1.201 g cobalt(II) nitrate hexahydrate (Co(NO₃)₂·6H₂O) and 0.5152 g aluminum(III) nitrate nonahydrate (Al(NO₃)₃·9H₂O) in 100 mL of EtOH. 7.5 g SVP 651 was added slowly to the solution while magnetically stirring to prevent clumping. The precursor solution was stirred overnight with heating to 60° C. under reflux conditions to completely dissolve all solids.

Solution 7. A solution of 7.5% (w/v) nylon SVP 651 and 10% (w/v) total lithium, nickel, manganese, and cobalt nitrates (1:0.6:0.2:0.2 Li:Ni:Mn:Co molar ratio) in ethanol (EtOH, 190 proof) was used as an electrospinning precursor for lithium nickel manganese cobalt oxide (NMC 622) fibers. The precursor solution was prepared by dissolving 1.941 g lithium nitrate (LiNO₃), 4.9050 g nickel(II) nitrate hexahydrate (Ni(NO₃))₂·6H₂O), 1.4108 g manganese(II) nitrate tetrahydrate (Mn(NO₃))₂·4H₂O) and 1.6206 g cobalt(II) nitrate hexahydrate (Co(NO₃)₂·6H₂O) in 100 mL of EtOH. 7.5 g SVP 651 was added slowly to the solution while magnetically stirring to prevent clumping. The precursor solution was stirred overnight with heating to 60° C. under reflux conditions to completely dissolve all solids.

Electrospinning

Samples from solutions 1-6 were prepared using a pendant drop apparatus, that is, a syringe filled with polymer solution. A high voltage is applied to a needle attached to the syringe and the polymer solution is pumped at a specified pump rate. As the drop of the polymer solution emerges from the needle, it forms a Taylor cone under the influence of the electrostatic field. At sufficiently high voltages, a jet is emitted from the Taylor cone which undergoes extension and fine fibers are formed and deposited on the media attached to a rotating mandrel which acts as the collector.

Fibers were formed onto a support layer wrapped around a cylinder (having a diameter 10.16 cm and rotating at 300 rpm) by electrospinning at a voltage of 24 kV and at a distance of 10.16 cm from the syringe or syringes delivering the polymer solution or solutions at a pump rate of 0.02 mL/min. After electrospinning, the formed fine fibers were stored in a desiccator prior to subsequent thermal treatment at 550° C. for one hour.

Six nonwoven fiber layers from the sample prepared from solutions 1-6 were deposited separately on a 0.2 mm thick, spunbond nylon scrim having a basis weight of 70 g/m² and a solidity of 28% (Media Grade 23200) by spinning the four electrospinning the solutions 1-6 separately. Solutions were delivered at the same pump rate (0.02 mL/minute) and for the same duration (5 minutes).

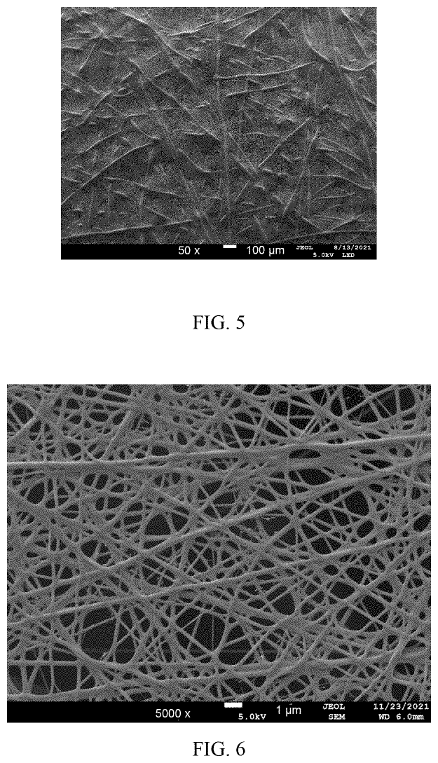

FIG. 5 shows a scanning electron microscopy image of fibers formed from electrospinning solution 3 of Example 1.

FIG. 6 shows a scanning electron microscopy image of fibers formed from electrospinning solution 5 in Example 1.

FIG. 7 shows a scanning electron microscopy image of fibers formed from electrospinning solution 6 in Example 1.

Heat Treatment

All samples were subjected to a post-electrospinning treatment to convert the as-spun nonwovens into active cathode materials. After electrospinning, formed fibers were peeled from the substrate and placed in a ceramic boat lined with aluminum foil. Prior to loading samples into a quartz tube furnace, the furnace was preheated to 100° C. and maintained at the elevated temperature for 20 minutes with dry compressed air used as a purge gas to remove moisture from the furnace walls. Next, the electrospun fibers were loaded into the tube furnace and heat-treated for one hour at 550° C. using the same dry compressed air. A heating rate of 20° C./min as used for the heating ramp.

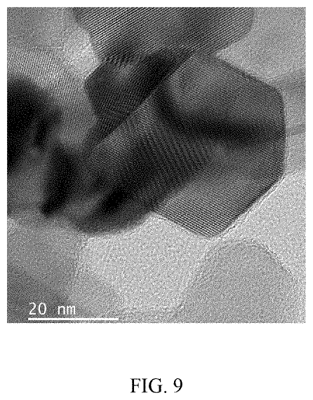

FIG. 8 and FIG. 9 show transmission electron microscopy images of LiCoO₂ nanoparticles formed after applying a decomposition treatment to the sacrificial nonwoven layer created from solution 3. FIG. 9 shows a uniform thin amorphous carbon coating, formed in situ, around individual highly crystalline nanoparticles.

The heat-treated samples were characterized to determine the crystallinity via x-ray scattering spectroscopy with the diffractometer in reflection mode. The D8 DISCOVER 2D x-ray microdiffractometer (available from Bruker Corporation in Billerica, Mass.) is equipped with a two-dimensional VANTEC detector, video camera/laser alignment system, and a Co K_{α} x-ray radiation point source (1=1.79 Å), which is conditioned with a graphite monochromator. It is also equipped with point collimators of varying sizes and a x, y, z sample stage. The samples were fixed to a Si wafer using paste as-received with no breakdown of the crystals into fine powder. The samples were separately aligned in x, y, z directions. An 800 μm collimator was used and the sample to detector distance was kept at 20 cm. Twenty measurement frames were scanned at 20/10, 40/20, 60/30, 80/40° θ/ω respectively for 600 seconds each. Area detector images were converted to one-dimensional intensity vs. 2θ data sets by using an averaging integration algorithm. GADDS was used to convert patterns to polar figures.

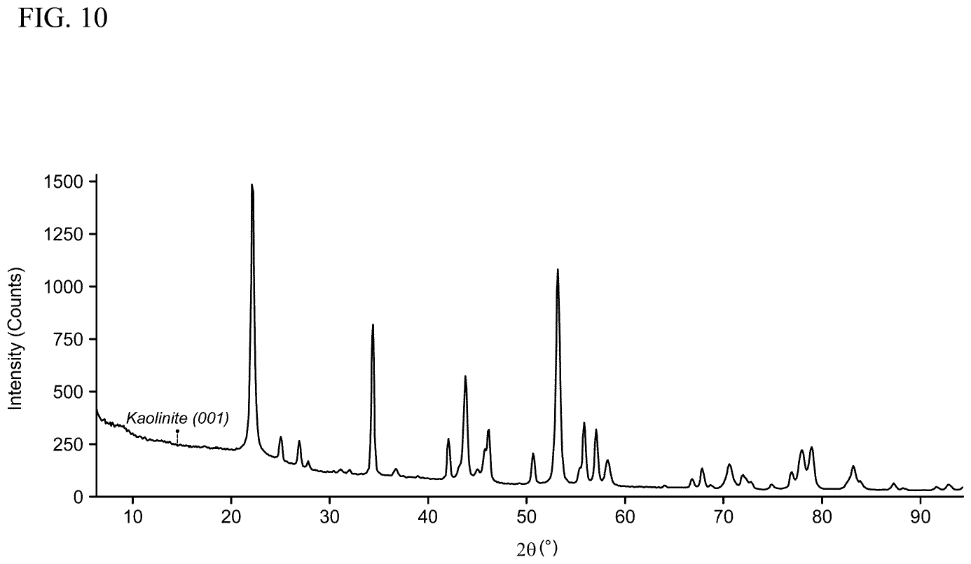

FIG. 10 shows an x-ray spectrum of LiCoO₂ nanoparticles formed after applying a decomposition treatment to the sacrificial nonwoven layer created from solution 3. The nanoparticles exhibit a high level of crystallinity and no amorphous content

### Example 2A

Example 2A describes the process for making a cathode assembly. The nanoparticles generated according to Example 1 are isolated. The isolated nanoparticles and a binder polymer are electrospun creating a nonwoven layer on a current collector substrate.

After the heat treatment step in Example 1, the nanoparticles may be isolated from the samples using conventional techniques such as filtering and sieving. Additionally, nanoparticles of a desired size may be sequestered using additional filtering techniques.

The isolated nanoparticles, a conductor material, and a binder polymer, may be dissolved in a solvent producing a homogenous mixture. The solvent may be chosen to discourage the dissociation of the nanoparticles into their component ion species. The solution may be electrospun according to the conditions provided in Example 1, except that the media attached to a rotating mandrel may be a material that is suitable as current collector. If the media attached to the rotating mandrel is not a suitable as current collector material, the nonwoven layer may be removed from the mandrel media and adhered to a material that is suitable as current collector following the electrospinning process.

The nonwoven layer may be subjected to post-electrospinning treatments. For example, the nonwoven layer may be placed in a desiccator, or the nonwoven layer could be adhered to the current collector through known mechanical and chemical processes.

### Example 2B

Samples were prepared from three mixtures including a polymer, carbon black particles, and solvent. The carbon black particles were used in leu of lithium cobalt oxide (LiCoO₂, LCO) particles due to more rigorous health protocols for handling of LCO.

Mixture 1. A mixture of 10% (w/v) PVdF and 30% (w/w) TimCal Super C65 Conductive Carbon Black in a mixed solvent of 6:4 (v/v) DMF and acetone was combined. The mixture was mixed using a FlackTek 330-100 speedmixer at 2000 rpm for 10 minutes before being used as a trial electrospinning solution.

Mixture 2. A mixture of 10% (w/v) PVdF and 50% (w/w) TimCal Super C65 Conductive Carbon Black in a mixed solvent of 6:4 (v/v) DMF and acetone was combined. The mixture was mixed using a FlackTek 330-100 speedmixer at 2000 rpm for 20 minutes before being used as a trial electrospinning solution.

Mixture 3. A mixture of 15% (w/v) PVdF and 3.8% (w/w) TimCal Super C65 Conductive Carbon Black in a mixed solvent of 6:4 (v/v) DMF and acetone was combined. The mixture was mixed using a FlackTek 330-100 speedmixer at 2000 rpm for 20 minutes before being used as a trial electrospinning solution. This percentage of C65 solids aligns with the number of conductive materials used in current commercial applications, which is typically 3% (w/w).

Electrospinning

Samples from Mixtures 1-3 were prepared using a pendant drop apparatus as described above with regard to Example 1.

Fibers were formed onto a support layer (Reynolds Wrap Aluminum Foil Wrap) wrapped around a cylinder (having a diameter 10.16 cm and rotating at 300 rpm) by electrospinning at various voltages and pump rates for a set run time of 5 minutes.

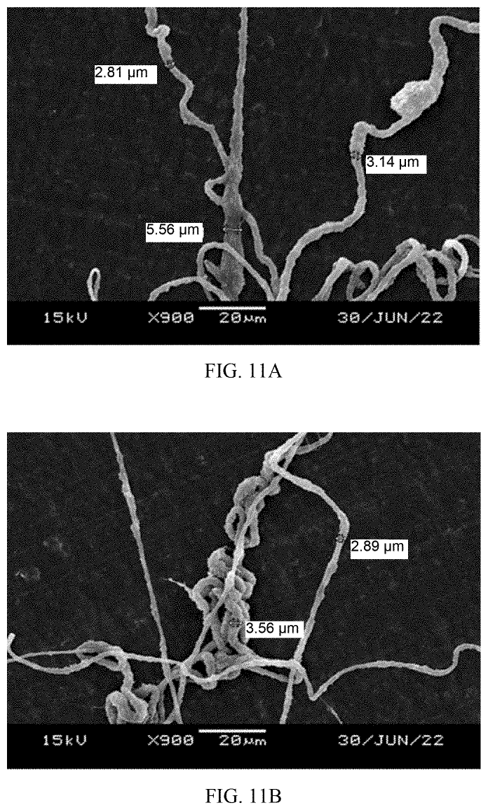

Two samples were prepared and ran using mixture 1. Both samples were run at a syringe to collector distance of 8 cm and at a rate of 0.75 mL/h. Sample 1A was collected at a voltage of 20 kV and the sample 1B at a voltage of 15 kV. Both samples were then cut and adhered to a SEM stub, which was then sputter coated using silver for higher visibility and analyzed using the SEM (JEOL JSM-5900LV) where characteristics, such as fiber diameter, were recorded using the program's scalar measurement tool. The SEM images are shown in FIGS. 11A (sample 1A) and 11B (sample 1B).

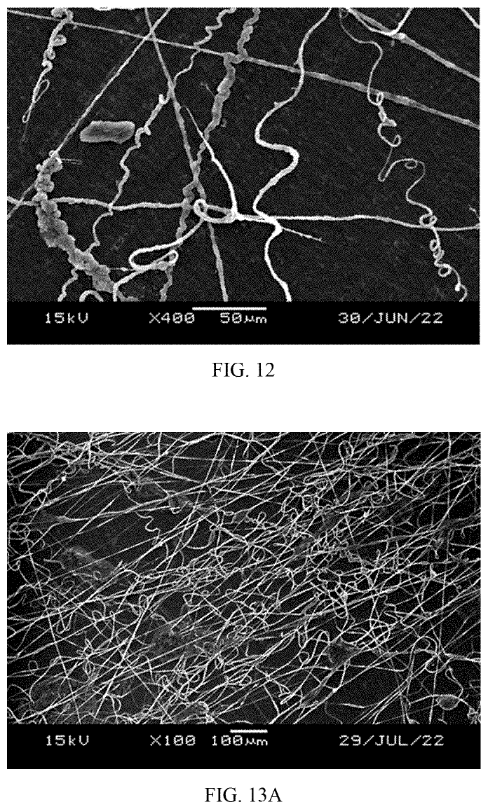

Sample 2 was run using Mixture 2 at a syringe to collector distance of 10 cm, voltage of 8 kV, and a pump rate of 1 mL/hr. The sample was then cut and adhered to a SEM stub, which was then sputter coated using silver for higher visibility and analyzed using the SEM (JEOL JSM-5900LV). The SEM image is shown in FIG. 12.

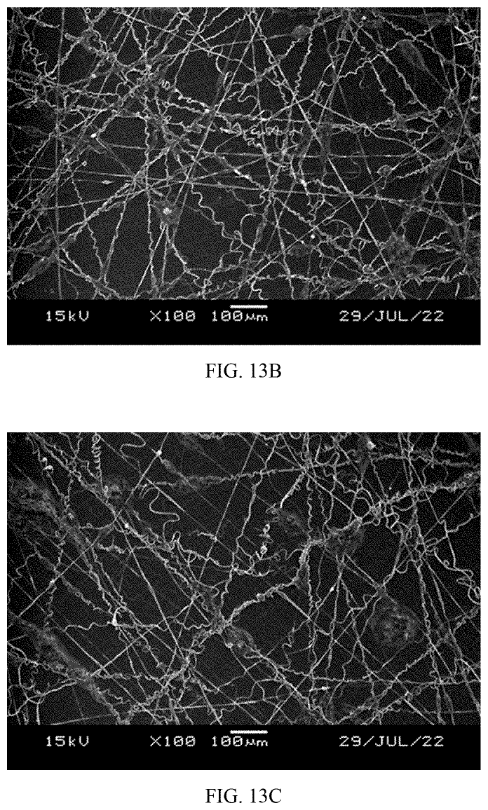

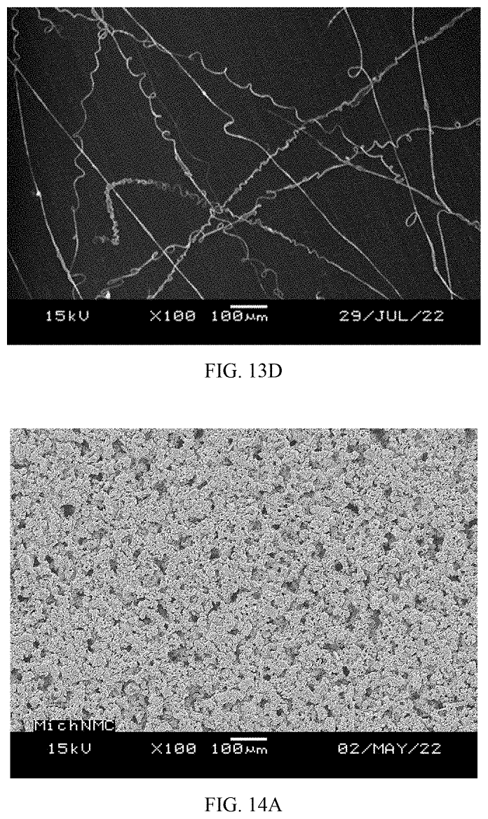

Four samples (3A, 3B, 3C, and 3D) were run using Mixture 3. Each of the samples was prepared with a syringe to collector distance of 10 cm. The first two (3A and 3B) were both run at a rate of 7.5 mL/h, with one sample (3A) run at a voltage of 20 kV and the other (3B) run at 30 kV. The final two (3C and 3D) were both run at a voltage of 25 kV with pump rates of 10 mL/h (3C) and 5 mL/h (3D). The samples were then cut and adhered to a SEM stub, which was then sputter coated using silver for higher visibility and analyzed using the SEM (JEOL JSM-5900LV). The SEM images are shown in FIGS. 13A (sample 3A), 13B (sample 3B), 13C (sample 3C), and 13D (sample 3D).

### Example 3

The cathode assembly of Example 2 may be used in a lithium-ion battery.

The effectiveness of the cathode assembly of Example 2 in a battery setting may be tested by employing the cathode assembly in a lithium-ion coin cell. The lithium-ion coin cell containing the cathode assembly of Example 2 may be used to assess various properties of the cathode assembly including, the C-rate, the areal and volumetric capacity at fast and slow charge/discharge rates, the capacity retention, energy density, and stability of the cathode over the course of use.

### Example 4

A catalyst assembly may be produced using the processes described in Example 1 and Example 2 with a few differences. First, instead of nanoparticles including a cathode active compound, the nanoparticles of the catalyst assembly include a catalytically active compound. As such, the salts used to make the solutions that are electrospun are salts that may dissolve into ion species that can react to form a catalytically active compound. Second, instead of a current collector substrate, the substrate is made of a material that either aids in or does not interfere in the catalytic reaction. Third, a conductive component may be unnecessary for the catalyst assembly.

### Example 5

A cathode assembly using active materials of Example 1 may be prepared via traditional slurry-casting methods and used in a lithium-ion battery.

The effectiveness of the cathode assembly in a battery setting may be tested by employing the cathode assembly in a lithium-ion coin cell. The lithium-ion coin cell containing the cathode assembly may be used to assess various properties of the cathode assembly including, the C-rate, the areal and volumetric capacity at fast and slow charge/discharge rates, the capacity retention, energy density, and stability of the cathode over the course of use.

Mixture 4. A mixture of: a) LiNi_{0.6}Mn_{0.2}Co_{0.2}O₂ (NMC 622) nanoparticles produced as described from Solution 7 in Example 1, b) 8 wt % polyvinylidene fluoride (PVdF, molecular weight=630,000 g/mol) in N-methyl-2pyrrolidone, and c) TimCal Super C65 Conductive Carbon Black was combined at mass ratios of 94:3:3 using a FlackTek 330-100 speedmixer at 2000 rpm for 10 minutes.

Cathode Assembly Via Slurry-Casting

Mixture 4 was applied as a wet film (150-180 micrometer thickness) onto an aluminum foil current collector (14-15 micrometer thickness) by slurry-casting using an AFA-III Automatic Thick Film Coater (available from MTI Corporation). The film was then transferred into a vacuum oven (Isotemp Vacuum Oven Model 282A from Fisher Scientific) heated at 110° C. at −15 mm Hg and allowed to dry for at least 1 hour. Afterwards, the dried cathode assembly was calendared at ambient temperature to a final thickness of 60 micrometers using a benchtop hot rolling press such as the MSK-HRP-01 (from MTI Corporation). The total mass loading on dry basis is approximately 10 mg/cm′.

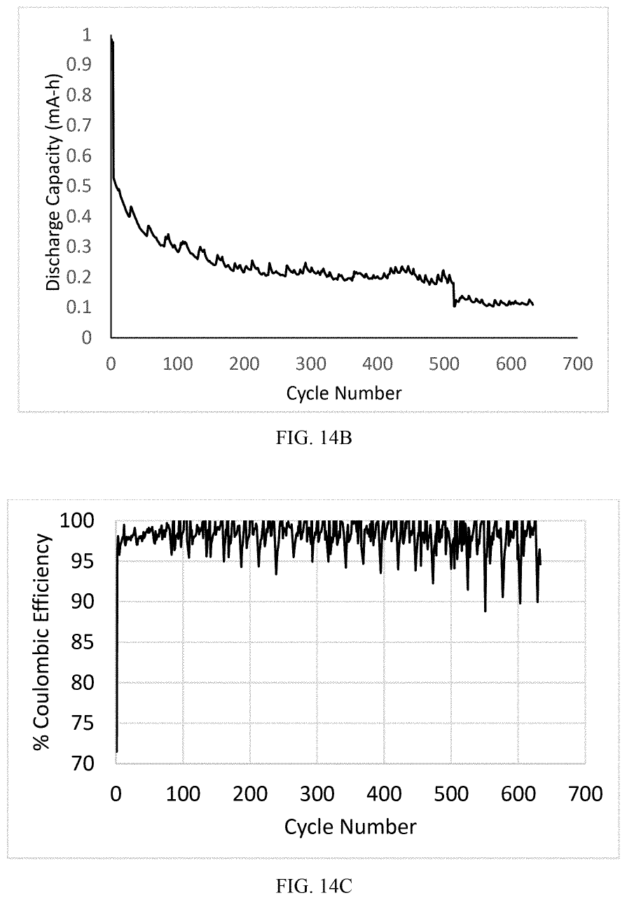

An SEM image of the cathode assembly using NMC 622 of Example 1 is shown in FIG. 14A.

Coin Cell Assembly and Testing

The cathode assembly was transferred into an Argon glove box and used as a cathode in CR2032 coin cells with a half-cell configuration against lithium metal foil separated by a Celgard separator and using 1 M LiPF₆ in 3/7 ethyl carbonate/ethyl methyl carbonate solvent mixture as electrolyte. The coin cells were then loaded into Maccor coin cell testers using the following program: a) initial charge at 0.1 C-rate followed by b) three charge/discharge formation cycles at 0.1 C-rate and then c) charge/discharge cycles at 1 C-rate until total discharge capacity has dropped to at least 10% of initial discharge capacity (as measured from Cycle 1).

The plot of the measured discharge capacity with increasing number of charge-discharge cycles is shown in FIG. 14B. The plot of the measured coulombic efficiencies with increasing number of charge-discharge cycles is shown in FIG. 14C.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This disclosure is not intended to be unduly limited by the illustrative embodiments and examples set forth herein and that such examples and embodiments are presented by way of example only with the scope of the disclosure intended to be limited only by the claims set forth here.

All headings are for the convenience of the reader and should not be used to limit the meaning of the text that follows the heading, unless so specified.

1. A composition comprising:
an electrospun nonwoven material comprising:
a fiber having an average diameter of less than 5 μm comprising:
a sacrificial polymer present at 40 weight-% to 60 weight-% of a total weight of the electrospun nonwoven layer; and
a first ion species and a second ion species dispersed on the sacrificial polymer and distributed along the fiber,
the first ion species and the second ion species being ion species of at least one salt, the at least one salt being present at 60 weight-% or less of a weight-% of a total salt,
the weight-% of the total salt relative to a weight-% of the sacrificial polymer is 1 part or more of the total salt weight-% to every 6 parts of the sacrificial polymer weight-%.

2. The composition of claim 1, wherein the at least one salt comprises NiCl₂, Ni(CH₃COO)₂, ZnSO₄, Zn(CH₃COO)₂, KCl, KAuCl₄, CoCl₂, Co(CH₃COO)₂, CuCl₂, Cu(NO₃)₂, PdCl₆, K₂PdCl₆, Na₂PtCl₄, K₂PtBr₄, Ni(NO₃)₂, Co(NO₃)₂, Mn(NO₃)₂, Al(NO₃)₃, Fe(NO₃)₂, LiNO₃, LiH₂PO₄, Fe(CH₃COO)₂, NiSO₄, CoSO₄, Li₂SO₄, MnSO₄, FeSO₄, Al₂(SO₄)₃, Al(OCH₃)₃, Al(CH₃COO)₃, or a combination thereof.

3. The composition of claim 1, wherein the sacrificial polymer is polyvinylpyrrolidone, polyethyleneglycol, nylon, polyurethane, polyvinyl alcohol, polyvinylacetate, polyacrylonitrile, polyacrylate, or a combination thereof.

4. The composition of claim 1, wherein the weight-% of the total salt relative to the weight-% of sacrificial polymer is from 1:6 to 2:1, from 1:3 to 5:3, from 2:3 to 5:3, from 2:3 to 4:3, or from 1:3 to 4:3.

5. A composition comprising an electrospun nonwoven layer comprising:
a substrate; and
a fiber deposited onto the substrate by electrospinning, the fiber comprising:
a polymer; and
a plurality of nanoparticles dispersed on the polymer and distributed across the fiber, the plurality of nanoparticles having a particle size range from 0.01 μm to 0.5 μm, each nanoparticle comprising a plurality of at least one compound species,
the fiber having an average diameter of less than 5 μm.

6. The composition of claim 5, comprising a plurality of the fibers forming a first fiber layer, the composition further comprising:
a second fiber layer comprising second fibers deposited onto the first fiber layer by electrospinning; the second fibers comprising:
a second polymer; and
a second plurality of nanoparticles dispersed on the second polymer and distributed across the fiber, the second plurality of nanoparticles having a particle size range from 0.01 μm to 0.5 μm, each nanoparticle comprising a plurality of at least one compound species,
wherein the first fiber layer has a solidity that is at least 1.1 times of a solidity of the second fiber layer.

7. The composition of claim 5, wherein the polymer is a binder polymer.

8. The composition of claim 7, wherein the polymer comprises one or more polyamides, polysulfones, polyethers, polyesters, polyamines, polyalcohols, polyurethanes, polycarbonates, polyaromatics, photosensitive polymers, polyimides, polyacrylates, polyvinylidenedifluoride, or a combination thereof.

9. The composition of claim 5, wherein the substrate is a current collector and comprises Cu foil, Al foil, Pt foil, Ni foil, a woven substrate, a nonwoven substrate, an artificial solid electrolyte interface, or a combination thereof.

10. The composition of claim 9, wherein the current collector forms a part of an electrode assembly disposed within a battery.

11. The composition of claim 9, wherein the at least one compound species comprises LiCoO₂, LiFePO₄, LiMn₂O₄, LiNiO₂, Li(NiₓMn_{y}Co_{z})O₂, Li(NiₓAl_{y}Co_{z})O₂, or a combination thereof, wherein x+y+z=1.

12. The composition of claim 5, wherein the substrate forms a part of a catalyst assembly and comprises silicon dioxide, aluminum dioxide, ceramic, or combinations thereof.

13. The composition of claim 12, wherein the at least one compound species comprises PbSe, AuPt, AuPd, PtPd, PtRu, PtAg, PtCu, FeRu, FeCu, FeRh, CuCe, AuCu, PtIr, NiCu, NiSn, NiAl, PtAl₂, PtMg, PtSn, PtCo, PdCo, PdTi, PtRh, NiAu, RhAg, TiO₂, NiO, or a combination thereof.

14. The composition of claim 5, wherein the plurality of nanoparticles is a first plurality of nanoparticles with each nanoparticle comprising a first compound species, the composition further comprising a second plurality of nanoparticles with each nanoparticle comprising a second compound species different from the first compound species.

15. A method comprising:
dissolving at least one salt and a sacrificial polymer in a solvent to form a solution, the solution comprising:
the sacrificial polymer;
a first ion species;
a second ions species; and
the solvent;
electrospinning the solution to form a sacrificial nonwoven material comprising:
a fiber comprising:
the sacrificial polymer; and
the first ion species and the second ion species dispersed on the polymer and distributed along the fiber.

16. The method of claim 15 further comprising:
decomposing at least a portion of the sacrificial nonwoven material resulting in a plurality of nanoparticles, each nanoparticle comprising a plurality of at least one compound species, the at least one compound species comprising a reaction product of at least the first ion species and the second ion species, the plurality of nanoparticles having a particle size range from 0.02 μm to 0.5 μm.

17. The method of claim 16 further comprising:
spinning a mixture onto a substrate, the mixture comprising:
a binder polymer; and
the plurality of nanoparticles,
the electrospinning of the mixture resulting in a second nonwoven layer comprising a second fiber comprising:
the binder polymer; and
nanoparticles from the plurality of nanoparticles, dispersed within the binder polymer and distributed across the fiber.

18. The method of claim 17, wherein the second fiber has an average diameter of less than 5 μm.

19. The method of claim 15, wherein the sacrificial polymer comprises polyvinylpyrrolidone, polyethylene glycol, polyvinyl alcohol, polyvinylacetate, polyacrylonitrile, polyacrylate, polyamides, polysulfones, polyethers, polyesters, polyamines, polyalcohols, polyurethanes, polycarbonates, polyaromatics, photosensitive polymers, polyimides, or a combination thereof.

20. The method of claim 15, wherein the binder polymer is selected from polyamides, polysulfones, polyethers, polyesters, polyamines, polyalcohols, polyurethanes, polycarbonates, polyaromatics, photosensitive polymers, polyimides, polyvinylacetates, polyacrylonitriles, polyacrylates, polyvinylidenedifluorides, or a combination thereof.

21. A composition prepared by the method of claim 17.
